(19) United States
(12) Patent Application Publication
(10) Pub. No.: US 2018/0340139 A1
(43) Pub. Date: Nov. 29, 2018

(54) INTERACTION BETWEEN QUATERNARY COMPOUNDS AND ANIONIC SURFACTANTS - FOAM ENHANCEMENT AND STABILIZATION AND PREFERRED FOAMING ANTIMICROBIAL COMPOSITIONS

(71) Applicant: Ecolab USA Inc., Saint Paul, MN (US)

(72) Inventors: Victor Fuk-Pong Man, Saint Paul, MN (US); Derrick Richard Anderson, Saint Paul, MN (US); Amanda Ruth Blattner, Saint Paul, MN (US)

(21) Appl. No.: 16/036,535

(22) Filed: Jul. 16, 2018

Related U.S. Application Data
(63) Continuation of application No. 15/445,431, filed on Feb. 28, 2017.
(60) Provisional application No. 62/400,275, filed on Sep. 27, 2016.

(51) Int. Cl. C11D 3/48; C11D 11/00; C11D 1/75; C11D 1/66; C11D 1/62; A01N 25/16; C11D 1/14; C11D 1/04; A01N 33/12; C11D 1/22

(52) U.S. Cl. CPC C11D 3/48; C11D 11/0023; C11D 1/75; C11D 1/662; C11D 1/22; A01N 25/16; C11D 1/143; C11D 1/04; A01N 33/12; C11D 1/62

(57) ABSTRACT

The present disclosure describes antimicrobial, sanitizing and other applications employing a synergistic combination of a quaternary ammonium compound and an anionic surfactant. The present disclosure is also related to non-antimicrobial applications employing a synergistic combination of a quaternary ammonium compound and an anionic and/or nonionic surfactant. The present disclosure is related to various forms of concentrated or use compositions containing the quaternary ammonium compound and an anionic surfactant (and in certain embodiments nonionic surfactants). In particular, the present disclosure provides compositions having desired foaming enhancement and methods employing the same for applications such as pot and pan compositions, hand soaps, facility sanitizing, and other soil removal applications with foam stabilization.

### CROSS REFERENCE TO RELATED APPLICATIONS

This Continuation application of U.S. Ser. No. 15/445,431, filed on Feb. 28, 2017, which claims priority under 35 U.S.C. § 119 to provisional application Ser. No. 62/400,275, filed Sep. 27, 2016, both of which are herein incorporated by reference in their entirety.

### FIELD OF THE INVENTION

The present disclosure is related to the field of surface activation for antimicrobial, sanitizing and other applications employing a synergistic combination of a quaternary ammonium compound and an anionic surfactant. The present disclosure is also related to non-antimicrobial applications employing a synergistic combination of a quaternary ammonium compound and an anionic surfactant. The present disclosure is related to various forms of concentrated or use compositions containing the quaternary ammonium compound and an anionic surfactant. In particular, the present disclosure provides compositions having desired foaming enhancement and methods employing the same for applications such as pot and pan compositions, hand soaps, and other soil removal applications with foam stabilization.

### BACKGROUND OF THE INVENTION

Antimicrobial agents are chemical compositions that are used to prevent microbiological contamination and deterioration of products, materials, and systems. Antimicrobial agents and compositions are used, for example, as disinfectants or sanitizers in association with hard surface cleaning, food preparation, hospitality services, hospital and medical uses, and hand soaps. Of the diverse categories of antimicrobial agents and compositions, quaternary ammonium compounds represent one of the largest of the classes of agents in use. At low concentrations, quaternary ammonium type antimicrobial agents are bacteriostatic, fungistatic, algistatic, sporostatic, and tuberculostatic. At medium concentrations they are bactericidal, fungicidal, algicidal, and viricidal against lipophilic viruses. Quaternary ammonium compounds are known to have difficulty in retaining kill efficacy for sufficient antimicrobial efficacy. Therefore, it is desirable to boost the antimicrobial activity of a chemical such as a quaternary ammonium compound.

Heavily soiled wares can require multiple cleaning steps to remove the soils from the surfaces of the wares. Pots and pans used for prepping, cooking, and baking ware in full service restaurants can be particularly difficult to clean in a dishmachine due to the caramelized soil baked on to the surface of the ware. Some full service restaurants have attempted to overcome this issue by using, as a pre-step to washing the pots and pans in the dishmachine, a 3-compartment sink for soaking the pots and pans. Exemplary soaking solutions include water, pot and pan detergent solutions, or silverware presoaks. Components of these compositions typically include metal protectors, surfactants, alkalinity sources and the like. Surfactants are the single most important cleaning ingredient in cleaning products. The surfactants reduce the surface tension of water by adsorbing at the liquid-gas interface. They also reduce the interfacial tension between oil and water by adsorbing at the liquid-liquid interface. When dissolved in water, surfactants give a product the ability to remove soil from surfaces. Each surfactant molecule has a hydrophilic head that is attracted to water molecules and a hydrophobic tail that repels water and simultaneously attaches itself to oil and grease in soil. These opposing forces loosen the soil and suspend it in the water.

Surfactants do the basic work of detergents and cleaning compositions by breaking up stains and keeping the soil in the water solution to prevent re-deposition of the soil onto the surface from which it has just been removed. Surfactants disperse soil that normally does not dissolve in water. Environmental regulations, consumer habits, and consumer practices have forced new developments in the surfactant industry to produce lower-cost, higher-performing, and environmentally friendly products.

There remains an ongoing need for antimicrobial compositions employing both quaternary ammonium compounds and surfactants, as well as non-antimicrobial soil removal compositions, having foam stabilization for the use compositions. Many cleaning compositions include a foaming agent to increase contact time on surfaces to be cleaned. Such compositions are presently used in many applications, such as retail, industrial and institutional including grease cutters, clinging lime scale removers, shower wall cleaners, bathtub cleaners, hand sanitizing gels, disinfectant gels, hand-soaps, teat dips, coatings, stabilized enzymes, structured liquids, and the like. The most widely used foaming agent is cocamide DEA, or cocamide diethanolamine, a diethanolamide made by reacting a mixture of fatty acids from coconut oils (cocamide) with diethanolamine. The agent may also been known as lauramide diethanolamine, Coco Diethanolamide, coconut oil amide of diethanolamine, Lauramide DEA, Lauric diethanolamide, Lauroyl diethanolamide, and Lauryl diethanolamide.

Accordingly, it is an objective of the claimed disclosure to develop concentrated and use liquid compositions and methods of using quaternary ammonium compounds for various soil removal applications to provide desired a antimicrobial efficacy. Still further, it is an object of the present disclosure to provide enhanced soil removal in non-antimicrobial applications. In each aspect of the disclosure suitable foam stabilization is desired while providing safe, environmentally friendly and economically feasible compositions for various applications of use.

It is a further object of the invention to provide a synergistic composition of a quaternary ammonium compound and anionic surfactants to provide such improvements and synergistic surface activity while maintaining desired foam stabilization.

Other objects, advantages and features of the present invention will become apparent from the following specification taken in conjunction with the accompanying drawings.

### BRIEF SUMMARY OF THE INVENTION

An advantage of the invention is the antimicrobial efficacy enhanced by the combination of quaternary ammonium compounds and anionic surfactants. In additional embodiments non-antimicrobial compositions employ the combination of the quaternary ammonium compounds and anionic surfactants for soil removal with stabilized foam profiles and may further include a nonionic surfactant. In an aspect, an antimicrobial composition comprises: a quaternary ammonium compound having the formula:

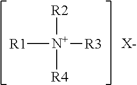

wherein groups R1, R2, R3, and R4 are independently selected from a C20 or less alkyl or alkoxy chain length, X— is an anion, and an anionic surfactant having a C6-C18 chain length. In an aspect, the composition is a solid or liquid concentrate that is soluble in water, has a pH of about 1 to about 12 in a use solution, and provides at least a 3 log microbial kill on a treated surface.

In an aspect, a non-antimicrobial composition comprises: a propoxylated quaternary ammonium compound having the formula:

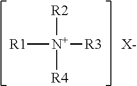

wherein groups R1, R2, R3 and R4 are independently selected from a C20 or less alkyl or alkoxy chain length, and wherein at least one of R1, R2, R3 and R4 is a propoxylated group, X— is an anion; an anionic surfactant having a C6-C18 chain length; and at least one nonionic surfactant. In an aspect, the composition is a solid or liquid concentrate (and optionally a super concentrate) that is soluble in water at an actives level of at least 18% without the addition of a viscoelastic reducing agent. In a further aspect, the composition has a pH of about 1 to about 12 in a use solution, and provides enhanced soil removal with a stabilized foam in the presence of soil.

In an aspect, a method of cleaning a surface comprises providing a liquid or solid composition as described according to the invention to a surface; and optionally rinsing the surface in need thereof, wherein the composition provides commercially acceptable cleaning performance.

While multiple embodiments are disclosed, still other embodiments of the present invention will become apparent to those skilled in the art from the following detailed description, which shows and describes illustrative embodiments of the invention. Accordingly, the drawings and detailed description are to be regarded as illustrative in nature and not restrictive.

### BRIEF DESCRIPTION OF THE DRAWINGS

FIG. 1 shows an interval plot of the percentage of soil removal using various commercial controls (antimicrobial compositions) compared to compositions containing only a nonionic surfactant and anionic surfactant.

FIG. 2 shows an interval plot of the percentage of soil removal using various commercial controls (antimicrobial compositions) compared to compositions containing only a nonionic surfactant and distinct anionic surfactants than those depicted in FIG. 1.

FIG. 3 shows an interval plot of the percentage of soil removal using various commercial controls (antimicrobial compositions) compared to compositions according to the present disclosure containing a quaternary ammonium compound, nonionic surfactant and anionic surfactant.

FIGS. 4-5 show graphical depictions of the amount of foam present in a system with a stabilized effect over time with exposure to soil concentrations utilizing compositions containing a quaternary ammonium compound in addition to the nonionic surfactant and anionic surfactant. The figures depict measured foam height as drops of soil are added the various systems at 110° F. (FIG. 4) and 80° F. (FIG. 5).

FIG. 6 shows an interval plot of the percentage of soil removal using various commercial controls (antimicrobial compositions) compared to compositions according to the present disclosure containing a quaternary ammonium compound, nonionic surfactant and anionic surfactant.

FIG. 7 shows a graphical depiction of the amount of foam present in a system with a stabilized effect over time with exposure to soil concentrations utilizing compositions containing a quaternary ammonium compound in addition to the nonionic surfactant and anionic surfactant.

FIG. 8 shows an interval plot of the percentage of soil removal using various commercial controls (antimicrobial compositions) compared to compositions according to the present disclosure containing a quaternary ammonium compound, nonionic surfactant and anionic surfactant.

FIG. 9 shows an interval plot of the percentage of soil removal using various commercial controls (antimicrobial compositions) compared to compositions according to the present disclosure containing a quaternary ammonium compound, nonionic surfactant and anionic surfactant when tested on various surfaces.

FIG. 10 is a graphical representation of the average foam height of quaternary ammonium and/or anionic surfactant solutions as described in Example 2.

FIG. 11 shows a graphical representation of the average foam height of experimental solutions as described in Example 3.

FIG. 12A-12C shows representative images of the foam height of quaternary ammonium and/or anionic surfactant solutions as described in Example 3. FIG. 12A shows the initial foam profile (no soil), FIG. 12B shows the foam profile in contact with 6 drops soybean oil, and FIG. 12C shows a close measurement of the pictures of FIG. 12B.

Various embodiments of the present invention will be described in detail with reference to the drawings, wherein like reference numerals represent like parts throughout the several views. Reference to various embodiments does not limit the scope of the invention. Figures represented herein are not limitations to the various embodiments according to the invention and are presented for exemplary illustration of the invention.

### DETAILED DESCRIPTION OF THE PREFERRED EMBODIMENT

The embodiments of this invention are not limited to particular compositions, methods of making and/or methods of employing the same for hard surface cleaning, which can vary and are understood by skilled artisans. It is further to be understood that all terminology used herein is for the purpose of describing particular embodiments only, and is not intended to be limiting in any manner or scope. For example, as used in this specification and the appended claims, the singular forms “a,” “an” and “the” can include plural referents unless the content clearly indicates otherwise. Further, all units, prefixes, and symbols may be denoted in its SI accepted form.

Numeric ranges recited within the specification are inclusive of the numbers defining the range and include each integer within the defined range. Throughout this disclosure, various aspects of this invention are presented in a range format. It should be understood that the description in range format is merely for convenience and brevity and should not be construed as an inflexible limitation on the scope of the invention. Accordingly, the description of a range should be considered to have specifically disclosed all the possible sub-ranges as well as individual numerical values within that range. For example, description of a range such as from 1 to 6 should be considered to have specifically disclosed sub-ranges such as from 1 to 3, from 1 to 4, from 1 to 5, from 2 to 4, from 2 to 6, from 3 to 6 etc., as well as individual numbers within that range, for example, 1, 2, 3, 4, 5, and 6. This applies regardless of the breadth of the range.

So that the present invention may be more readily understood, certain terms are first defined. Unless defined otherwise, all technical and scientific terms used herein have the same meaning as commonly understood by one of ordinary skill in the art to which embodiments of the invention pertain. Many methods and materials similar, modified, or equivalent to those described herein can be used in the practice of the embodiments of the present invention without undue experimentation, the preferred materials and methods are described herein. In describing and claiming the embodiments of the present invention, the following terminology will be used in accordance with the definitions set out below.

The term “about,” as used herein, refers to variation in the numerical quantity that can occur, for example, through typical measuring and liquid handling procedures used for making concentrates or use solutions in the real world; through inadvertent error in these procedures; through differences in the manufacture, source, or purity of the ingredients used to make the compositions or carry out the methods; and the like. The term “about” also encompasses amounts that differ due to different equilibrium conditions for a composition resulting from a particular initial mixture. Whether or not modified by the term “about”, the claims include equivalents to the quantities.

The term “actives” or “percent actives” or “percent by weight actives” or “actives concentration” are used interchangeably herein and refers to the concentration of those ingredients involved in cleaning expressed as a percentage minus inert ingredients such as water or salts.

As used herein, the term “cleaning” refers to a method used to facilitate or aid in soil removal, bleaching, microbial population reduction, and any combination thereof. As used herein, the term “microorganism” refers to any noncellular or unicellular (including colonial) organism. Microorganisms include all prokaryotes. Microorganisms include bacteria (including cyanobacteria), spores, lichens, fungi, protozoa, virinos, viroids, viruses, phages, and some algae. As used herein, the term “microbe” is synonymous with microorganism.

The term “commercially acceptable cleaning performance” refers generally to the degree of cleanliness, extent of effort, or both that a typical consumer would expect to achieve or expend when using a cleaning product or cleaning system to address a typical soiling condition on a typical substrate. This degree of cleanliness may, depending on the particular cleaning product and particular substrate, correspond to a general absence of visible soils, or to some lesser degree of cleanliness. For example, a shower cleaner or toilet bowl cleaner would be expected by a typical consumer to achieve an absence of visible soils when used on a moderately soiled but relatively new hard surface, but would not be expected to achieve an absence of visible soils when used on an old hard surface which already bears permanent stains such as heavy calcite deposits or iron discoloration. Cleanliness may be evaluated in a variety of ways depending on the particular cleaning product being used (e.g., ware or laundry detergent, rinse aid, hard surface cleaner, vehicular wash or rinse agent, or the like) and the particular hard or soft surface being cleaned (e.g., ware, laundry, fabrics, vehicles, and the like), and normally may be determined using generally agreed industry standard tests or localized variations of such tests. In the absence of such agreed industry standard tests, cleanliness may be evaluated using the test or tests already employed by a manufacturer or seller to evaluate the cleaning performance of its phosphorus-containing cleaning products sold in association with its brand.

For the purpose of this patent application, successful microbial reduction is achieved when the microbial populations are reduced by at least about 50%, or by significantly more than is achieved by a wash with water. Larger reductions in microbial population provide greater levels of protection.

The term “hard surface” refers to a non-resilient cleanable substrate, for example materials made from ceramic, stone, glass or hard plastics including showers, sinks, toilets, bathtubs, countertops, windows, mirrors, transportation vehicles, walls, wooden or tile floors, patient-care equipment (for example diagnostic equipment, shunts, body scopes, wheel chairs, bed frames, etc.), surgical equipment and the like.

The term “improved cleaning performance” refers generally to achievement by a substitute cleaning product or substitute cleaning system of a generally greater degree of cleanliness or with generally a reduced expenditure of effort, or both, when using the substitute cleaning product or substitute cleaning system rather than a branded cleaning product to address a typical soiling condition on a typical substrate that does not employ the combination of the quaternary ammonium compound and anionic surfactant of the present disclosure. This degree of cleanliness may, depending on the particular cleaning product and particular substrate, correspond to a general absence of visible soils, or to some lesser degree of cleanliness, as explained above.

As used herein, the term “sanitizer” refers to an agent that reduces the number of bacterial contaminants to safe levels as judged by public health requirements. In an embodiment, sanitizers for use in this invention will provide at least a 99.999% reduction (5-log order reduction). These reductions can be evaluated using a procedure set out in Germicidal and Detergent Sanitizing Action of Disinfectants, Official Methods of Analysis of the Association of Official Analytical Chemists, paragraph 960.09 and applicable sections, 15th Edition, 1990 (EPA Guideline 91-2). According to this reference a sanitizer should provide a 99.999% reduction (5-log order reduction) within 30 seconds at room temperature, 25±2° C., against several test organisms.

Differentiation of antimicrobial “-cidal” or “-static” activity, the definitions which describe the degree of efficacy, and the official laboratory protocols for measuring this efficacy are considerations for understanding the relevance of antimicrobial agents and compositions. Antimicrobial compositions can affect two kinds of microbial cell damage. The first is a lethal, irreversible action resulting in complete microbial cell destruction or incapacitation. The second type of cell damage is reversible, such that if the organism is rendered free of the agent, it can again multiply. The former is termed microbiocidal and the later, microbistatic. A sanitizer and a disinfectant are, by definition, agents which provide antimicrobial or microbiocidal activity. In contrast, a preservative is generally described as an inhibitor or microbistatic composition

As used herein, the term “substantially free” refers to compositions completely lacking the component or having such a small amount of the component that the component does not affect the performance of the composition. The component may be present as an impurity or as a contaminant and shall be less than 0.5 wt-%. In another embodiment, the amount of the component is less than 0.1 wt-% and in yet another embodiment, the amount of component is less than 0.01 wt-%.

The term “surfactant” as used herein is a compound that contains a lipophilic segment and a hydrophilic segment, which when added to water or solvents, reduces the surface tension of the system.

An “extended chain surfactant” is a surfactant having an intermediate polarity linking chain, such as a block of poly-propylene oxide, or a block of poly-ethylene oxide, or a block of poly-butylene or a mixture thereof, inserted between the surfactant's conventional lipophilic segment and hydrophilic segment.

The term “weight percent,” “wt-%,” “percent by weight,” “% by weight,” and variations thereof, as used herein, refer to the concentration of a substance as the weight of that substance divided by the total weight of the composition and multiplied by 100. It is understood that, as used here, “percent,” “%,” and the like are intended to be synonymous with “weight percent,” “wt-%,” etc.

The methods and compositions of the present invention may comprise, consist essentially of, or consist of the components and ingredients of the present invention as well as other ingredients described herein. As used herein, “consisting essentially of” means that the methods and compositions may include additional steps, components or ingredients, but only if the additional steps, components or ingredients do not materially alter the basic and novel characteristics of the claimed methods and compositions.

Antimicrobial Quaternary/Anionic Compositions

The antimicrobial compositions according to the disclosure beneficially provide synergistic surface active, provide enhanced foaming profiles, and are cost effective. In an aspect, the antimicrobial compositions according to the disclosure comprise, consist of and/or consist essentially of a quaternary ammonium compound and an anionic surfactant. In another aspect, the antimicrobial compositions according to the disclosure comprise, consist of and/or consist essentially of a quaternary ammonium compound, an anionic surfactant and at least one additional functional ingredient. According to the invention, the antimicrobial compositions having foam stabilization do not include a nonionic surfactant. As one skilled in the art will ascertain, the nonionic surfactant inactivates quaternary ammonium compounds and therefore would not be included in the compositions. The antimicrobial compositions according to the disclosure overcome the insufficient surface activity of the quaternary ammonium compounds while providing efficacious antimicrobial capabilities with stabilized foam profiles. The complexes of quaternary ammonium compound and anionic surfactant become synergistically more surface active and efficacious, which beneficially provide improved performance under stressed conditions, including for example high soil conditions during which foam profiles are expected to become destabilized and therefore provide insufficient contact and soil removal for applications requiring stabilized foaming, including for example pot and pan cleaning and hand soaps. Beneficially, the selection of the anionic surfactant and quaternary ammonium compound can activate the quaternary ammonium compound and provide such stabilized foaming for the antimicrobial composition. This combination of quaternary ammonium compound and anionic surfactant having a desired anionic head group and chain length is a non-oxidative approach to enhancing the surface activity of and the antimicrobial efficacy of the quaternary ammonium compound complex in an unexpected manner.

Embodiments of Antimicrobial Quaternary/Anionic Compositions

Exemplary ranges of the antimicrobial compositions according to the invention are shown in Table 1 each in weight percentage, and additional amounts of water can be added to formulations. Exemplary formulations employing the antimicrobial compositions according to the invention are shown in Table 1A and include, for example, hand soap compositions, soaking compositions, and pot and pan compositions. Table 2B shows generic antimicrobial compositions according to the invention which are particularly suitable for hand wash applications of use described herein. Table 2C shows exemplary antimicrobial compositions particularly well suited for pot and pan and/or soaking compositions according to embodiments of the invention.

TABLE 1A

| | First | Second | Third |
|---|---|---|---|
| | Exemplary | Exemplary | Exemplary |
| Material | Range wt-% | Range wt-% | Range wt-% |
| Quaternary ammonium | 1-75 | 1-50 | 1-30 |
| compound | | | |
| Anionic surfactant | 1-50 | 1-30 | 1-20 |
| Additional Functional | 0-50 | 0.001-40 | 0.1-40 |
| Ingredients | | | |

TABLE 1B

| | First | Second | Third |
|---|---|---|---|
| | Exemplary | Exemplary | Exemplary |
| Material | Range wt-% | Range wt-% | Range wt-% |
| Quaternary ammonium | 1-75 | 1-50 | 1-30 |
| compound | | | |
| Anionic surfactant | 1-50 | 1-30 | 1-20 |
| Additional Functional | 0.1-50 | 0.1-40 | 1-40 |
| Ingredients (e.g. emollient) | | | |
| Water | Remainder | Remainder | Remainder |

TABLE 1C

| | First | Second | Third |
|---|---|---|---|
| | Exemplary | Exemplary | Exemplary |
| Material | Range wt-% | Range wt-% | Range wt-% |
| Quaternary ammonium | 1-75 | 1-50 | 1-30 |
| compound | | | |
| Anionic surfactant | 1-50 | 1-30 | 1-20 |
| Additional Functional | 0.1-50 | 0.1-40 | 1-40 |
| Ingredients (e.g. additional | | | |
| surfactants) | | | |
| Water | Remainder | Remainder | Remainder |

Non-Antimicrobial Quaternary/Anionic Compositions

The non-antimicrobial compositions according to the disclosure beneficially provide enhanced soil removal without the anionic and nonionic surfactants interfering with the soil removal performance of the quaternary ammonium compound while providing stabilized foaming profiles, and are cost effective. In an aspect, the non-antimicrobial compositions provide a synergy between the quaternary ammonium compound and the anionic surfactant as well as between the quaternary ammonium compound, anionic surfactant and the nonionic surfactant, such that the compositions have significantly reduced anionic surfactant concentration in formulations while maintaining at least equal, and preferably enhanced, foam profiles, including producing stable foams in various embodiment disclosed herein.

In an aspect, the non-antimicrobial compositions according to the disclosure comprise, consist of and/or consist essentially of a quaternary ammonium compound, nonionic surfactant, and an anionic surfactant. In another aspect, the non-antimicrobial compositions according to the disclosure comprise, consist of and/or consist essentially of a quaternary ammonium compound, nonionic surfactant, an anionic surfactant and at least one additional functional ingredient. The non-antimicrobial compositions according to the disclosure overcome the insufficient surface activity of the quaternary ammonium compounds while providing stabilized foam profiles by further incorporating a nonionic surfactant into the formulation. Beneficially and unexpectedly, the tertiary surfactant package containing the quaternary ammonium compound, nonionic surfactant, an anionic surfactant provides an synergistic effect as confirmed by examples pursuant to the present disclosure. The complexes of quaternary ammonium compound and anionic surfactant although synergistically more surface active and efficacious are further combined with a nonionic surfactant to provide high foaming compositions, which beneficially provide improved performance under stressed conditions, including for example high soil conditions during which foam profiles are expected to become destabilized and therefore provide insufficient contact and soil removal for applications requiring stabilized foaming, including for example pot and pan cleaning. Beneficially, the selection of the anionic and nonionic surfactants and quaternary ammonium compound enable the quaternary ammonium compound to form micelles for the quaternary ammonium compounds which maintain soil removal without the antimicrobial efficacy. Still further, there is a benefit of a significant viscosity reduction, resulting in ability of highly concentrated formulations according to the present disclosure. In an aspect, detergents formulated with high level of anionic surfactants can become viscous, however the combination according to the present disclosure overcomes any gelling concerns and provides ease of manufacturing and dispensing of the product from a container. Moreover, there are benefits in formulations such that diluted compostions (having a large amount of water in the formulation) are not shipped at great expense. Instead, the increased viscosity and therefore compactness of the compositions permit the transport of less weight, making shipping more economical; less packaging is required so that smaller and more readily disposable containers can be used; there is less chance for messy leakage; and less shelf space is required in the retail stores.

Nothing in the specification shall be also understood to limit the forming of a “super-concentrated” composition based upon the composition described above. Such a super-concentrated ingredient composition is essentially the same as the antimicrobial compositions described above except in that they include a lesser amount of water. In some aspects, these concentrated compositions can have an increased actives (quaternary ammonium compound and surfactants) in the solid or liquid concentrates, including at least about 18%, at least about 20%, at least about 30%, at least about 40%, or at least about 50%. As a result of the increased concentration of actives the water concentration is greatly reduced. Beneficially, these concentrated compositions are achieved without the use of any viscoelasticity reducing agents while still being capable of conventional commercial dispensing techniques (e.g. aspirators).

Embodiments of Non-Antimicrobial Quaternary/Anionic Compositions

Exemplary ranges of the non-antimicrobial compositions, including soaking compositions, according to the invention are shown in Tables 2A-2B each in weight percentage, and additional amounts of water can be added to formulations. Exemplary formulations employing the non-antimicrobial compositions include, for example hand soap compositions, soaking compositions, and pot and pan compositions. Table 2A shows generic non-antimicrobial compositions according to the invention which is suitable for various applications of use described herein. Table 2B shows exemplary non-antimicrobial compositions particularly well suited for pot and pan foaming compositions according to embodiments of the invention.

TABLE 2A

| | First | Second | Third |
|---|---|---|---|
| | Exemplary | Exemplary | Exemplary |
| Material | Range wt-% | Range wt-% | Range wt-% |
| Quaternary ammonium | 1-75 | 1-50 | 1-15 |
| compound | | | |
| Anionic surfactant | 1-50 | 1-30 | 2-20 |
| Nonionic surfactant | 1-60 | 1-40 | 2-30 |
| Additional Functional | 0-50 | 0.001-40 | 0.1-20 |
| Ingredients | | | |

TABLE 2B

| | First | Second | Third |
|---|---|---|---|
| | Exemplary | Exemplary | Exemplary |
| Material | Range wt-% | Range wt-% | Range wt-% |
| Quaternary ammonium | 1-25 | 1-15 | 1-10 |
| compound (preferably | | | |
| propoxylated quat) | | | |
| Anionic surfactant | 1-50 | 1-40 | 5-30 |
| Nonionic surfactant (or | 5-60 | 10-50 | 25-50 |
| combination thereof e.g. APG | | | |
| and amine oxide) | | | |
| Additional Functional | 0-50 | 0.001-40 | 0.1-20 |
| Ingredient | | | |
| Water | Dilute to | Dilute to | Dilute to |
| | 100% | 100% | 100% |

In an aspect of the invention, the non-antimicrobial composition is a solid or liquid concentrate having an actives level of at least about 18%, at least about 20%, at least about 30%, at least about 40%, or at least about 50%. As referred to herein the actives include the quaternary ammonium compound, anionic surfactants and any nonionic surfactants.

In a further aspect, the non-antimicrobial composition is a concentrate that is substantially free of any viscoelastic reducing agents. In a further aspect, the compositions are free of any added viscoelastic reducing agent, including for example ethanol, propylene glycol, glycerin, inorganic salts (e.g. sodium chloride) or the like.

The antimicrobial compositions and non-antimicrobial compositions according to the disclosure and as set forth in Tables 1-2 can be provided in single use or multiple use compositions. In a preferred aspect, the composition is a concentrated liquid or solid composition. Various solids can be employed according to the invention and without limiting the scope of the invention. It should be understood that compositions and methods embodying the invention are suitable for preparing a variety of solid compositions, as for example, a cast, extruded, pressed, molded or formed solid pellet, block, tablet, and the like. In some embodiments, the solid composition can be formed to have a weight of 50 grams or less, while in other embodiments, the solid composition can be formed to have a weight of 50 grams or greater, 500 grams or greater, or 1 kilogram or greater.

According to the disclosure, the antimicrobial compositions and non-antimicrobial can be concentrated compositions as set forth in Tables 1-2 have pHs from about 0 to about 12. In some aspects, the compositions of the invention have a pH between about 1 and about 12. In another embodiment the composition has a pH between about 4 and about 10. In another embodiment the composition has a pH between about 5 and about 9 and such compositions are particularly suitable for pot and pan applications where contact to skin is made. Without limiting the scope of invention, the numeric ranges are inclusive of the numbers defining the range and include each integer within the defined range. According to aspects of the invention, the diluted use solutions may have acidic or neutral to alkaline pH depending upon a particular application of use thereof and the desired non-corrosive nature of the applications.

Quaternary Ammonium Compound

The compositions according to the invention include at least one quaternary ammonium compound. In an aspect, the quaternary ammonium compound is an antimicrobial “quat.” The term “quaternary ammonium compound” or “quat” generally refers to any composition with the formula

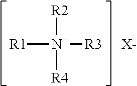

where R1-R4 are alkyl groups that may be alike or different, substituted or unsubstituted, saturated or unsaturated, branched or unbranched, and cyclic or acyclic and may contain ether, ester, or amide linkages; they may be aromatic or substituted aromatic groups. X— is an anionic, preferably an anion. Certain quats are known to have antimicrobial activity. Accordingly, any quaternary ammonium compound with antimicrobial activity can be used in the composition of the invention.

In an aspect, at least one of R1-R4 is alkoxylated, preferably ethoxylated and/or propoxylated, including a polyoxyalkylene chain of the following formulas:

—CH₂—CH₂OC₃H₆ₙOH

—(PO)ₐ or —(PO)ₐ(EO)_{b}, or —(PO)_{b}(EO)ₐ

Wherein n is an integer up to 50, from 10-50, from 20-50, from 30-50, or from 35-45. Where a is an integer from 5 to 100 or 1 to 60 and b is an integer from 1 to 50 or 0 to 30 and a plus b is from 1 to 60 and a>b or a ratio of a/b be of at least 2 or 4 or 5.

In an aspect, at least one of R1-R4 is alkoxylated, including a polyoxyalkylene chain of the following formulas:

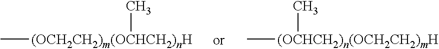

Wherein m is from 0 to 30, n is from 1 to 60, and m plus n is from 1 to 60, and n>m. In an aspect, a propoxylated quaternary ammonium compound according to the formula above where R1, R2 and R3 are independently lower alkyl groups (C₁-C₄ alkyl groups), R4 may be a polyoxyalkylene chain, and X— comprises an anion. Additional disclosure of suitable propoxylated, non polymeric quats suitable for the present disclosure is set forth in U.S. Pat. Nos. 6,878,681 and 7,951,245, which are herein incorporated by reference in their entirety. An example of a commercially-available propoxylated, non polymeric quat is Variquat CC42 NS (polyoxypropylene methyl diethyl ammonium chloride) having the formula (C₃H₆O)n(C₇H₁₈NO)Cl. In an aspect, the Variquat CC42 (polyoxypropylene methyl diethyl ammonium chloride) has an average chain length (n) from about 20-50, average of about 30.

In an aspect of the invention, the propoxylated quaternary ammonium compound has a total molecular weight of propylene oxide of at least about 60%.

The term “anionic counter ion” includes any ion that can form a salt with quaternary ammonium. Examples of suitable counter ions include halides such as chlorides and bromides, propionates, methosulphates, saccharinates, ethosulphates, hydroxides, acetates, phosphates, and nitrates. Preferably, the anionic counter ion is chloride.

In some embodiments quaternary ammoniums having carbon chains of less than 20 are included in compositions of the invention. In other embodiments quaternary ammoniums having carbon chains of C6-C18, C12-C18, C12-C16 and C6-C10 are included in compositions of the invention. Examples of quaternary ammonium compounds useful in the present invention include but are not limited to alkyl dimethyl benzyl ammonium chloride, octyl decyl dimethyl ammonium chloride, dioctyl dimethyl ammonium chloride, and didecyl dimethyl ammonium chloride to name a few. A single quaternary ammonium or a combination of more than one quaternary ammonium may be included in compositions of the invention. Further examples of quaternary ammonium compounds useful in the present invention include but are not limited to benzethonium chloride, ethylbenzyl alkonium chloride, myristyl trimethyl ammonium chloride, methyl benzethonium chloride, cetalkonium chloride, cetrimonium bromide (CTAB), carnitine, dofanium chloride, tetraethyl ammonium bromide (TEAB), domiphen bromide, benzododecinium bromide, benzoxonium chloride, choline, cocamidopropyl betaine (CAPB), denatonium, and mixtures thereof. In an aspect, combinations of quaternary ammonium compounds are particularly preferred for compositions of the invention, such as for example the commercially-available products Bardac 205/208M.

In some embodiments depending on the nature of the R group, the anion, and the number of quaternary nitrogen atoms present, the antimicrobial quats may be classified into one of the following categories: monoalkyltrimethyl ammonium salts; monoalkyldimethylbenzyl ammonium salts; dialkyldimethyl ammonium salts; heteroaromatic ammonium salts; polysubstituted quaternary ammonium salts; bis-quaternary ammonium salts; and polymeric quaternary ammonium salts. Each category will be discussed herein.

Monoalkyltrimethyl ammonium salts contain one R group that is a long-chain alkyl group, and the remaining R groups are short-chain alkyl groups, such as methyl or ethyl groups. Some non-limiting examples of monoalkyltrimethyl ammonium salts include cetyltrimethylammonium bromide, commercial available under the trade names Rhodaquat M242C/29 and Dehyquart A; alkyltrimethyl ammonium chloride, commercially available as Arquad 16; alkylaryltrimethyl ammonium chloride; and cetyldimethyl ethylammonium bromide, commercially available as Ammonyx DME.

Monoalkyldimethylbenzyl ammonium salts contain one R group that is a long-chain alkyl group, a second R group that is a benzyl radical, and the two remaining R groups are short-chain alkyl groups, such as methyl or ethyl groups. Monoalkyldimethylbenzyl ammonium salts are generally compatible with nonionic surfactants, detergent builders, perfumes, and other ingredients. Some non-limiting examples of monoalkyldimethylbenzyl ammonium salts include alkyldimethylbenzyl ammonium chlorides, commercially available as Barquat from Lonza Inc.; and benzethonium chloride, commercially available as Lonzagard, from Lonza Inc. Additionally, the monoalkyldimethylbenzyl ammonium salts may be substituted. Non-limiting examples of such salts include dodecyldimethyl-3,4-dichlorobenzyl ammonium chloride. Finally, there are mixtures of alkyldimethylbenzyl and alkyldimethyl substituted benzyl (ethylbenzyl) ammonium chlorides commercially available as BTC 2125M from Stepan Company, and Barquat 4250 from Lonza Inc.

Dialkyldimethyl ammonium salts contain two R groups that are long-chain alkyl groups, and the remaining R groups are short-chain alkyl groups, such as methyl groups. Some non-limiting examples of dialkyldimethyl ammonium salts include didecyldimethyl ammonium halides, commercially available as Bardac 22 from Lonza Inc.; didecyl dimethyl ammonium chloride commercially available as Bardac 2250 from Lonza Inc.; dioctyl dimethyl ammonium chloride, commercially available as Bardac LF and Bardac LF-80 from Lonza Inc.); and octyl decyl dimethyl ammonium chloride sold as a mixture with didecyl and dioctyl dimethyl ammonium chlorides, commercially available as Bardac2050 and 2080 from Lonza Inc.

Heteroaromatic ammonium salts contain one R group that is a long-chain alkyl group, and the remaining R groups are provided by some aromatic system. Accordingly, the quaternary nitrogen to which the R groups are attached is part of an aromatic system such as pyridine, quinoline, or isoquinoline. Some non-limiting examples of heteroaromatic ammonium salts include cetylpyridinium halide, commercially available as Sumquat 6060/CPC from Zeeland Chemical Inc.; 1-[3-chloroalkyl]-3,5,7-triaza-1-azoniaadamantane, commercially available as Dowicil 200 from The Dow Chemical Company; and alkyl-isoquinolinium bromide.

Polysubstituted quaternary ammonium salts are a monoalkyltrimethyl ammonium salt, monoalkyldimethylbenzyl ammonium salt, dialkyldimethyl ammonium salt, or heteroaromatic ammonium salt wherein the anion portion of the molecule is a large, high-molecular weight (MW) organic ion. Some non-limiting examples of polysubstituted quaternary ammonium salts include alkyldimethyl benzyl ammonium saccharinate, and dimethylethylbenzyl ammonium cyclohexylsulfamate.

Bis-quatemary ammonium salts contain two symmetric quaternary ammonium moieties having the general formula:

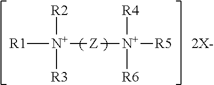

Where the R groups may be long or short chain alkyl, a benzyl radical or provided by an aromatic system. Z is a carbon-hydrogen chain attached to each quaternary nitrogen. Some non-limiting examples of bis-quaternary ammonium salts include 1,10-bis(2-methyl-4-aminoquinolinium chloride)-decane; and 1,6-bis[1-methyl-3-(2,2,6-trimethyl cyclohexyl)-propyldimethylammonium chloride] hexane or triclobisonium chloride.

In an aspect, the quaternary ammonium compound is a medium to long chain alkyl R group, such as from 8 carbons to about 20 carbons, from 8 carbons to about 18 carbons, from about 10 to about 18 carbons, and from about 12 to about 16 carbons, and providing a soluble and good antimicrobial agent.

In an aspect, the quaternary ammonium compound is a short di-alkyl chain quaternary ammonium compound having an R group, such as from 2 carbons to about 12 carbons, from 3 carbons to about 12 carbons, or from 6 carbons to about 12 carbons.

In an aspect, the quaternary ammonium compound is an alkyl benzyl ammonium chloride, a dialkyl benzyl ammonium chloride, a blend of alkyl benzyl ammonium chloride and dialkyl benzyl ammonium chloride, dodecyl dimethyl ammonium chloride, dioctyl dimethyl ammonium chloride, a blend of dodecyl dimethyl ammonium chloride and dioctyl dimethyl ammonium chloride, or mixtures thereof. In some emboidments, the quaternary ammonium compound is a quaternary functionalized alkyl polyglycosides (APG), or a poly quaternary APG.

In some embodiments, the quaternary ammonium compound is silane free.

In a preferred embodiment, the quaternary ammonium compound for an antimicrobial composition for contacting human skin (e.g. hand wash, pot and pan) include the benzyl quaternary ammonium compounds. In a preferred aspect, the alkyl benzyl ammonium chloride compounds are particularly well suited for contacting skin (including as commercially available under the tradename Uniquat QAC-50). An effective amount of the quaternary ammonium compound is provided in combination with the anionic surfactant providing antimicrobial efficacy (or soil removal) against a broad spectrum of microbes, including gram negative microbes such as E. coli, etc. Suitable concentrations of the quaternary ammonium compound in concentrate compositions include between about 1 wt-% to about 75 wt-%, about 1 wt-% to about 50 wt-%, about 10 wt-% to about 50 wt-%, about 10 wt-% to about 45 wt-%, about 10 wt-% to about 40 wt-%, about 1 wt-% to about 35 wt-%, about 1-wt-% to about 30 wt-%, about 1 wt-% to about 25 wt-%, about 1 wt-% to about 20 wt-%, about 1 wt-% to about 15 wt-%. Without being limited according to the invention, all ranges recited are inclusive of the numbers defining the range and include each integer within the defined range.

Suitable concentrations of the quaternary ammonium compound in a use solution for antimicrobial compositionsinclude between about 1 ppm and about 5000 ppm, between about 100 ppm and about 4000 ppm, between about 100 ppm and about 2500 ppm, between about 100 ppm and about 1500 ppm or between about 500 ppm and about 1500 ppm. Without being limited according to the invention, all ranges recited are inclusive of the numbers defining the range and include each integer within the defined range.

Suitable concentrations of the quaternary ammonium compound in a use solution for non-antimicrobial compositions include between about 0.1 ppm and about 500 ppm, between about 1 ppm and about 100 ppm, between about 1 ppm and about 75 ppm, between about 5 ppm and about 75 ppm, or between about 5 ppm and about 50 ppm. Without being limited according to the invention, all ranges recited are inclusive of the numbers defining the range and include each integer within the defined range.

Anionic Surfactants

The compositions according to the invention include at least one anionic surfactant. In other aspects, the compositions according to the invention include at least two anionic surfactants. Certain embodiments of the invention contemplate the use of one or more anionic surfactants which electrostatically interact or ionically interact with the positively charged polymer to enhance foam stability. Anionic surfactants are categorized as anionics because the charge on the hydrophobe is negative; or surfactants in which the hydrophobic section of the molecule carries no charge unless the pH is elevated to neutrality or above (e.g. carboxylic acids). Carboxylate, sulfonate, sulfate and phosphate are polar (hydrophilic) solubilizing groups found in anionic surfactants.

As those skilled in the art understand, anionics are excellent detersive surfactants and are therefore traditionally favored additions to heavy duty detergent compositions. Generally, anionics have high foam profiles which are useful for the present foaming cleaning compositions. Anionic surface active compounds are useful to impart special chemical or physical properties other than detergency within the composition.

The majority of large volume commercial anionic surfactants can be subdivided into five major chemical classes and additional sub-groups known to those of skill in the art and described in “Surfactant Encyclopedia,” Cosmetics & Toiletries, Vol. 104 (2) 71-86 (1989). The first class includes acylamino acids (and salts), such as acylgluamates, acyl peptides, sarcosinates (e.g. N-acyl sarcosinates), taurates (e.g. N-acyl taurates and fatty acid amides of methyl tauride), and the like. The second class includes carboxylic acids (and salts), such as alkanoic acids (and alkanoates), ester carboxylic acids (e.g. alkyl succinates), ether carboxylic acids, and the like. The third class includes sulfonic acids (and salts), such as isethionates (e.g. acyl isethionates), alkylaryl sulfonates, alkyl sulfonates, sulfosuccinates (e.g. monoesters and diesters of sulfosuccinate), and the like. A particularly preferred anionic surfactant is alpha olefin sulfonate. The fourth class includes sulfonic acids (and salts), such as isethionates (e.g. acyl isethionates), alkylaryl sulfonates, alkyl sulfonates, sulfosuccinates (e.g. monoesters and diesters of sulfosuccinate), and the like. The fifth class includes sulfuric acid esters (and salts), such as alkyl ether sulfates, alkyl sulfates, and the like. The fifth class includes sulfuric acid esters (and salts), such as alkyl ether sulfates, alkyl sulfates, and the like. A particularly preferred anionic surfactant is sodium laurel ether sulfate.

In an aspect, the anionic surfactant is linear or branched. In an aspect, the linear or branched anionic surfactant is a medium chain surfactant having from 6-18 carbon chain length, preferably from 6-12 carbon chain length, and more preferably from 6-10 carbon chain length. In an aspect, the linear or branched, medium chain anionic surfactant is alkoxylated. In an aspect, the linear or branched anionic surfactant is an alkoxylated medium chain surfactant having from 6-18 carbon chain length, preferably from 6-13 carbon chain length, and more preferably from 6-10 carbon. In an aspect, the anionic surfactant is a carboxylate. In an alternative aspect, the anionic surfactant is a weak acid anionic, such as a phosphate ester. In a still further alternative aspect, the anionic surfactant is a sulfonate and/or sulfate.

In an aspect, the anionic surfactants suitable for use in the present compositions include carboxylates. Anionic carboxylate surfactants suitable for use in the present compositions include carboxylic acids (and salts), such as alkanoic acids (and alkanoates), ester carboxylic acids (e.g. alkyl succinates), ether carboxylic acids, sulfonated fatty acids, such as sulfonated oleic acid, and the like Suitable carboxylic acids include for example decanoic acid, octanoic acid, nonanoic, ethylhexyl acid, and isononanionic acid. Such carboxylates include alkyl ethoxy carboxylates, alkyl aryl ethoxy carboxylates, alkyl polyethoxy polycarboxylate surfactants and soaps (e.g. alkyl carboxyls). Secondary carboxylates useful in the present compositions include those which contain a carboxyl unit connected to a secondary carbon. The secondary carbon can be in a ring structure, e.g. as in p-octyl benzoic acid, or as in alkyl-substituted cyclohexyl carboxylates. The secondary carboxylate surfactants typically contain no ether linkages, no ester linkages and no hydroxyl groups. Further, they typically lack nitrogen atoms in the head-group (amphiphilic portion). Suitable secondary soap surfactants typically contain 11-13 total carbon atoms, although more carbons atoms (e.g., up to 16) can be present. Suitable carboxylates also include acylamino acids (and salts), such as acylgluamates, acyl peptides, sarcosinates (e.g. N-acyl sarcosinates), taurates (e.g. N-acyl taurates and fatty acid amides of methyl tauride), and the like.

Suitable anionic surfactants include alkyl or alkylaryl ethoxy carboxylates of the following formula: R—O—(CH₂CH₂O)ₙ(CH₂)ₘ—CO₂X in which R is a C8-C22 alkyl group or

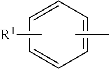

in which R.sup.1 is a C4-C16 alkyl group; n is an integer of 1-20; m is an integer of 1-3; and X is a counter ion, such as hydrogen, sodium, potassium, lithium, ammonium, or an amine salt such as monoethanolamine, diethanolamine or triethanolamine. In some embodiments, n is an integer of 4 to 10 and m is 1. In some embodiments, R is a C8-C16 alkyl group. In some embodiments, R is a C12-C14 alkyl group, n is 4, and m is 1.

Such alkyl and alkylaryl ethoxy carboxylates are commercially available. These ethoxy carboxylates are typically available as the acid forms, which can be readily converted to the anionic or salt form.

In an aspect, the anionic surfactants suitable for use in the present compositions include phosphate esters.

In an aspect, the anionic surfactants suitable for use in the present compositions include sulfonates and/or sulfates. In an aspect, the anionic surfactant suitable for use in the present compositions include alkyl ether sulfates, alkyl sulfates, the linear and branched primary and secondary alkyl sulfates, alkyl ethoxysulfates, fatty oleyl glycerol sulfates, alkyl phenol ethylene oxide ether sulfates, the C5-C17 acyl-N—(C1-C4 alkyl) and —N—(C1-C2 hydroxyalkyl) glucamine sulfates, and sulfates of alkylpolysaccharides such as the sulfates of alkylpolyglucoside, and the like. Also included are the alkyl sulfates, alkyl poly(ethyleneoxy) ether sulfates and aromatic poly(ethyleneoxy) sulfates such as the sulfates or condensation products of ethylene oxide and nonyl phenol (usually having 1 to 6 oxyethylene groups per molecule). Anionic sulfonate surfactants suitable for use in the present compositions also include alkyl sulfonates, the linear and branched primary and secondary alkyl sulfonates, and the aromatic sulfonates with or without substituents.

Examples of anionic carboxylate surfactants suitable for use in the compositions include organic acids such as hexanoic acid, heptanoic acid, octanoic acid, nonanoic acid, and decanoic acid. Examples of branched chain organic acids suitable for use in the 2-in-1 sanitizing rinse compositions include ethylhexyl carboxylate, isononanoic carboxylate, and tridecyl carboxylate. Examples of commercially available surfactants suitable for use in the 2-in-1 sanitizing rinse compositions include organic acids such as hexanoic acid, heptanoic acid, octanoic acid, nonanoic acid, decanoic acid, Colatrope INC, Isononanionic acid, Marlowet 4539 (C9-alcohol polyethylene glycol ether carboxylic acid available from Sasol), Emulsogen CNO (C8-alcohol 8 moles polyethylene glycol ether carboxylic acid available from Clariant), and Emulsogen DTC (C13-alcohol 7 moles polyethylene glycol ether carboxylic acid available from Clariant). It is further discovered according to the invention that phosphate esters serve to enhance the antimicrobial activity of a quaternary ammonium compound and are therefore suitable for use in the compositions.

In an aspect, the anionic surfactants can include one or more extended chain surfactants. These are surfactants that have, for example, an intermediate polarity poly-propylene oxide chain (or linker) inserted between the lipophilic tail group and hydrophilic polar head, which may be anionic or nonionic. Examples of lipophilic tails groups include hydrocarbons, alkyl ether, fluorocarbons or siloxanes. Examples of anionic and nonionic hydrophilic polar heads of the extended surfactant include, but are not necessarily limited to, groups such as polyoxyethylene sulfate, ethoxysulfate, carboxylate, ethoxy-carboxylate, C6 sugar, xylitol, di-xylitol, ethoxy-xylitol, carboxylate and xytol, carboxylate and glucose. In an aspect extended surfactants include a linker polypropylene glycol link.

Extended surfactants generally have the formula R-[L]x[O—CH₂—CH₂]y where R is the lipophilic moiety, a linear or branched, saturated or unsaturated, substituted or unsubstituted, aliphatic or aromatic hydrocarbon radical having from about 8 to 20 carbon atoms, L is a linking group, such as a block of poly-propylene oxide, a block of poly-ethylene oxide, a block of poly-butylene oxide or a mixture thereof; x is the chain length of the linking group ranging from 5-15; and y is the average degree of ethoxylation ranging from 1-5.

Anionic extended surfactants generally have the formula R-[L]x[O—CH₂—CH₂]y, or R-[L]x[O—CH₂—CH₂]_{y} M, where M is any ionic species such as carboxylates, sulfonates, sulfates, and phosphates and R is the lipophilic moiety, a linear or branched, saturated or unsaturated, substituted or unsubstituted, aliphatic or aromatic hydrocarbon radical having from about 8 to 20 carbon atoms, L is a linking group, such as a block of poly-propylene oxide, a block of poly-ethylene oxide, a block of poly-butylene oxide or a mixture thereof; x is the chain length of the linking group ranging from 5-15; and y is the average degree of ethoxylation ranging from 1-5. A cationic species will generally also be present for charge neutrality such as hydrogen, an alkali metal, alkaline earth metal, ammonium and ammonium ions which may be substituted with one or more organic groups. These extended chain surfactants attain low interfacial tension and/or high solubilization in a single phase microemulsion with oils, such as nontrans fats with additional beneficial properties including, but not necessarily limited to, insensitivity to temperature and irreversibility. For example, in one embodiment the emulsions may function over a relatively wide temperature range of from about 20 to about 280 C, alternatively from about 20 to about 180 C (350 F). Many extended chain anionic surfactants are commercially available from a number of sources, including those set forth in Table 1 of U.S. Pat. No. 9,034,813 which is a representative, nonlimiting listing of several examples of the same and is herein incorporated by reference in its entirety. In an embodiment, compositions according to the invention employ an extended chain anionic surfactant in combination with the quaternary ammonium compounds. Beneficially, use of the extended chain anionic surfactant which can employ a degree of propoxylation in the middle of the formula or structure impacts the viscosity of the composition and can be further combined with the foaming compositions disclosed herein. Additional description of extended chain anionic surfactants is disclosed in U.S. Pat. No. 9,410,110,

An effective amount of the anionic surfactant is provided in combination with the quaternary ammonium compound and/or nonionic surfactant including between about 1 wt-% to about 50 wt-%, about 1 wt-% to about 45 wt-%, about 1 wt-% to about 40 wt-%, about 1 wt-% to about 35 wt-%, about 1 wt-% to about 30 wt-%, about 1 wt-% to about 25 wt-%, about 1-wt-% to about 20 wt-%, about 1 wt-% to about 15 wt-%, or about 1 wt-% to about 10 wt-%. Without being limited according to the invention, all ranges recited are inclusive of the numbers defining the range and include each integer within the defined range.

An effective amount of the anionic surfactant is provided in combination with the quaternary ammonium compound to provide antimicrobial efficacy or soil removal. Suitable concentrations of the anionic surfactant in a use solution for antimicrobial compositions include between about 1 ppm and about 5,000 ppm, about 15 ppm and about 2,500 ppm, about 1 ppm and about 1,000 ppm, and preferably about 1 ppm and about 500 ppm. Without being limited according to the invention, all ranges recited are inclusive of the numbers defining the range and include each integer within the defined range.

Suitable concentrations of the anionic surfactant in a use solution for non-antimicrobial compositions include between about 0.1 ppm and about 1000 ppm, between about 1 ppm and about 200 ppm, between about 1 ppm and about 150 ppm, between about 5 ppm and about 150 ppm, or between about 5 ppm and about 100 ppm. Without being limited according to the invention, all ranges recited are inclusive of the numbers defining the range and include each integer within the defined range. Nonionic Surfactants

Useful nonionic surfactants are generally characterized by the presence of an organic hydrophobic group and an organic hydrophilic group and are typically produced by the condensation of an organic aliphatic, alkyl aromatic or polyoxyalkylene hydrophobic compound with a hydrophilic alkaline oxide moiety which in common practice is ethylene oxide or a polyhydration product thereof, polyethylene glycol. Practically any hydrophobic compound having a hydroxyl, carboxyl, amino, or amido group with a reactive hydrogen atom can be condensed with ethylene oxide, or its polyhydration adducts, or its mixtures with alkoxylenes such as propylene oxide to form a nonionic surface-active agent. The length of the hydrophilic polyoxyalkylene moiety which is condensed with any particular hydrophobic compound can be readily adjusted to yield a water dispersible or water soluble compound having the desired degree of balance between hydrophilic and hydrophobic properties. Useful nonionic surfactants include:

Block polyoxypropylene-polyoxyethylene polymeric compounds based upon propylene glycol, ethylene glycol, glycerol, trimethylolpropane, and ethylenediamine as the initiator reactive hydrogen compound. Examples of polymeric compounds made from a sequential propoxylation and ethoxylation of initiator are commercially available under the trade names Pluronic® and Tetronic® manufactured by BASF Corp. Pluronic® compounds are difunctional (two reactive hydrogens) compounds formed by condensing ethylene oxide with a hydrophobic base formed by the addition of propylene oxide to the two hydroxyl groups of propylene glycol. This hydrophobic portion of the molecule weighs from about 1,000 to about 4,000. Ethylene oxide is then added to sandwich this hydrophobe between hydrophilic groups, controlled by length to constitute from about 10% by weight to about 80% by weight of the final molecule. Tetronic® compounds are tetra-functional block copolymers derived from the sequential addition of propylene oxide and ethylene oxide to ethylenediamine. The molecular weight of the propylene oxide hydrotype ranges from about 500 to about 7,000; and, the hydrophile, ethylene oxide, is added to constitute from about 10% by weight to about 80% by weight of the molecule.

Condensation products of one mole of alkyl phenol wherein the alkyl chain, of straight chain or branched chain configuration, or of single or dual alkyl constituent, contains from about 8 to about 18 carbon atoms with from about 3 to about 50 moles of ethylene oxide. The alkyl group can, for example, be represented by diisobutylene, di-amyl, polymerized propylene, iso-octyl, nonyl, and di-nonyl. These surfactants can be polyethylene, polypropylene, and polybutylene oxide condensates of alkyl phenols. Examples of commercial compounds of this chemistry are available on the market under the trade names Igepal® manufactured by Rhodia and Triton® manufactured by Dow Chemical Company.

Condensation products of one mole of a saturated or unsaturated, straight or branched chain alcohol having from about 6 to about 24 carbon atoms with from about 3 to about 50 moles of ethylene oxide. The alcohol moiety can consist of mixtures of alcohols in the above delineated carbon range or it can consist of an alcohol having a specific number of carbon atoms within this range. Examples of like commercial surfactant are available under the trade names Neodol® manufactured by Shell Chemical Co. and Alfonic® manufactured by Sasol North America Inc.

Condensation products of one mole of saturated or unsaturated, straight or branched chain carboxylic acid having from about 8 to about 18 carbon atoms with from about 6 to about 50 moles of ethylene oxide. The acid moiety can consist of mixtures of acids in the above defined carbon atoms range or it can consist of an acid having a specific number of carbon atoms within the range.

In addition to ethoxylated carboxylic acids, commonly called polyethylene glycol esters, other alkanoic acid esters formed by reaction with glycerides, glycerin, and polyhydric (saccharide or sorbitan/sorbitol) alcohols have application in this invention for specialized embodiments, particularly indirect food additive applications. All of these ester moieties have one or more reactive hydrogen sites on their molecule which can undergo further acylation or ethylene oxide (alkoxide) addition to control the hydrophilicity of these substances. Care must be exercised when adding these fatty ester or acylated carbohydrates to compositions of the present invention containing amylase and/or lipase enzymes because of potential incompatibility.

Examples of nonionic low foaming surfactants include:

Compounds from (1) which are modified, essentially reversed, by adding ethylene oxide to ethylene glycol to provide a hydrophile of designated molecular weight; and, then adding propylene oxide to obtain hydrophobic blocks on the outside (ends) of the molecule. The hydrophobic portion of the molecule weighs from about 1,000 to about 3,100 with the central hydrophile including 10% by weight to about 80% by weight of the final molecule. These reverse Pluronics® are manufactured by BASF Corporation under the trade name Pluronic® R surfactants. Likewise, the Tetronic®R surfactants are produced by BASF Corporation by the sequential addition of ethylene oxide and propylene oxide to ethylenediamine. The hydrophobic portion of the molecule weighs from about 2,100 to about 6,700 with the central hydrophile including 10% by weight to 80% by weight of the final molecule.

Compounds from groups (1), (2), (3) and (4) which are modified by “capping” or “end blocking” the terminal hydroxy group or groups (of multi-functional moieties) to reduce foaming by reaction with a small hydrophobic molecule such as propylene oxide, butylene oxide, benzyl chloride; and, short chain fatty acids, alcohols or alkyl halides containing from 1 to about 5 carbon atoms; and mixtures thereof. Also included are reactants such as thionyl chloride which convert terminal hydroxy groups to a chloride group. Such modifications to the terminal hydroxy group may lead to all-block, block-heteric, heteric-block or all-heteric nonionics.

Additional examples of effective low foaming nonionics include:

The alkylphenoxypolyethoxyalkanols of U.S. Pat. No. 2,903,486 issued Sep. 8, 1959 to Brown et al. and represented by the formula

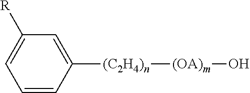

in which R is an alkyl group of 8 to 9 carbon atoms, A is an alkylene chain of 3 to 4 carbon atoms, n is an integer of 7 to 16, and m is an integer of 1 to 10.

The polyalkylene glycol condensates of U.S. Pat. No. 3,048,548 issued Aug. 7, 1962 to Martin et al. having alternating hydrophilic oxyethylene chains and hydrophobic oxypropylene chains where the weight of the terminal hydrophobic chains, the weight of the middle hydrophobic unit and the weight of the linking hydrophilic units each represent about one-third of the condensate.

The defoaming nonionic surfactants disclosed in U.S. Pat. No. 3,382,178 issued May 7, 1968 to Lissant et al. having the general formula Z[(OR)ₙOH]z wherein Z is alkoxylatable material, R is a radical derived from an alkaline oxide which can be ethylene and propylene and n is an integer from, for example, 10 to 2,000 or more and z is an integer determined by the number of reactive oxyalkylatable groups.

The conjugated polyoxyalkylene compounds described in U.S. Pat. No. 2,677,700, issued May 4, 1954 to Jackson et al. corresponding to the formula Y(C₃H₆O)ₙ (C₂H₄O)ₘH wherein Y is the residue of organic compound having from about 1 to 6 carbon atoms and one reactive hydrogen atom, n has an average value of at least about 6.4, as determined by hydroxyl number and m has a value such that the oxyethylene portion constitutes about 10% to about 90% by weight of the molecule.

The conjugated polyoxyalkylene compounds described in U.S. Pat. No. 2,674,619, issued Apr. 6, 1954 to Lundsted et al. having the formula Y[(C₃H₆Oₙ (C₂H₄O)ₘH]ₓ wherein Y is the residue of an organic compound having from about 2 to 6 carbon atoms and containing x reactive hydrogen atoms in which x has a value of at least about 2, n has a value such that the molecular weight of the polyoxypropylene hydrophobic base is at least about 900 and m has value such that the oxyethylene content of the molecule is from about 10% to about 90% by weight. Compounds falling within the scope of the definition for Y include, for example, propylene glycol, glycerine, pentaerythritol, trimethylolpropane, ethylenediamine and the like. The oxypropylene chains optionally, but advantageously, contain small amounts of ethylene oxide and the oxyethylene chains also optionally, but advantageously, contain small amounts of propylene oxide.

Additional conjugated polyoxyalkylene surface-active agents which are advantageously used in the compositions of this invention correspond to the formula: P[(C₃H₆O)ₙ(C₂H₄O)ₘH]ₓ wherein P is the residue of an organic compound having from about 8 to 18 carbon atoms and containing x reactive hydrogen atoms in which x has a value of 1 or 2, n has a value such that the molecular weight of the polyoxyethylene portion is at least about 44 and m has a value such that the oxypropylene content of the molecule is from about 10% to about 90% by weight. In either case the oxypropylene chains may contain optionally, but advantageously, small amounts of ethylene oxide and the oxyethylene chains may contain also optionally, but advantageously, small amounts of propylene oxide.

Polyhydroxy fatty acid amide surfactants suitable for use in the present compositions include those having the structural formula R₂CON_{R1}Z in which: R1 is H, C₁-C₄ hydrocarbyl, 2-hydroxy ethyl, 2-hydroxy propyl, ethoxy, propoxy group, or a mixture thereof; R₂ is a C₅-C₃₁ hydrocarbyl, which can be straight-chain; and Z is a polyhydroxyhydrocarbyl having a linear hydrocarbyl chain with at least 3 hydroxyls directly connected to the chain, or an alkoxylated derivative (preferably ethoxylated or propoxylated) thereof. Z can be derived from a reducing sugar in a reductive amination reaction; such as a glycityl moiety.

The alkyl ethoxylate condensation products of aliphatic alcohols with from about 0 to about 25 moles of ethylene oxide are suitable for use in the present compositions. The alkyl chain of the aliphatic alcohol can either be straight or branched, primary or secondary, and generally contains from 6 to 22 carbon atoms.

The ethoxylated C₆-C₁₈ fatty alcohols and C₆-C₁₈ mixed ethoxylated and propoxylated fatty alcohols are suitable surfactants for use in the present compositions, particularly those that are water soluble. Suitable ethoxylated fatty alcohols include the C₆-C₁₈ ethoxylated fatty alcohols with a degree of ethoxylation of from 3 to 50.

Suitable nonionic alkylpolysaccharide surfactants, particularly for use in the present compositions include those disclosed in U.S. Pat. No. 4,565,647, Llenado, issued Jan. 21, 1986. These surfactants include a hydrophobic group containing from about 6 to about 30 carbon atoms and a polysaccharide, e.g., a polyglycoside, hydrophilic group containing from about 1.3 to about 10 saccharide units. Any reducing saccharide containing 5 or 6 carbon atoms can be used, e.g., glucose, galactose and galactosyl moieties can be substituted for the glucosyl moieties. (Optionally the hydrophobic group is attached at the 2-, 3-, 4-, etc. positions thus giving a glucose or galactose as opposed to a glucoside or galactoside.) The intersaccharide bonds can be, e.g., between the one position of the additional saccharide units and the 2-, 3-, 4-, and/or 6-positions on the preceding saccharide units.

A further class of nonionic surfactants, which can be used as ingredients of the composition of the first component according to the invention, is that of the alkyl polyglycosides (APG). Suitable alkyl polyglycosides satisfy the general Formula RO(G)z where R is a linear or branched, particularly 2-methyl-branched, saturated or unsaturated aliphatic radical containing 8 to 22 and preferably 12 to 18 carbon atoms and G stands for a glycose unit containing 5 or 6 carbon atoms, preferably glucose. The degree of oligomerization z is a number between about 1.0 and about 4.0 and preferably between about 1.1 and about 1.8.

Fatty acid amide surfactants suitable for use the present compositions include those having the formula: R₆CON(R₇)₂ in which R₆ is an alkyl group containing from 7 to 21 carbon atoms and each R₇ is independently hydrogen, C₁-C₄ alkyl, C₁-C₄ hydroxyalkyl, or —(C₂H₄O)ₓH, where xis in the range of from 1 to 3.

The treatise Nonionic Surfactants, edited by Schick, M. J., Vol. 1 of the Surfactant Science Series, Marcel Dekker, Inc., New York, 1983 is an excellent reference on the wide variety of nonionic compounds generally employed in the practice of the present invention. A typical listing of nonionic classes, and species of these surfactants, is given in U.S. Pat. No. 3,929,678 issued to Laughlin and Heuring on Dec. 30, 1975. Further examples are given in “Surface Active Agents and detergents” (Vol. I and II by Schwartz, Perry and Berch). Additional disclosure of suitable nonionic surfactants for employing in combination with the anionic surfactant and quaternary ammonium compounds according to the invention aredislosed in U.S. Pat. No. 9,309,485, the entire contents of which are herein incorporated by reference in its entirety.

Semi-Polar Nonionic Surfactants

The semi-polar type of nonionic surface active agents are another class of nonionic surfactant useful in compositions of the present invention. Generally, semi-polar nonionics are high foamers and foam stabilizers, which can limit their application in CIP systems. However, within compositional embodiments of this invention designed for high foam cleaning methodology, semi-polar nonionics would have immediate utility. The semi-polar nonionic surfactants include the amine oxides, phosphine oxides, sulfoxides and their alkoxylated derivatives.

Amine oxides are tertiary amine oxides corresponding to the general formula:

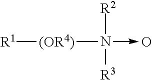

wherein the arrow is a conventional representation of a semi-polar bond; and, R¹, R², and R³ may be aliphatic, aromatic, heterocyclic, alicyclic, or combinations thereof. Generally, for amine oxides of detergent interest, R¹ is an alkyl radical of from about 8 to about 24 carbon atoms; R² and R³ are alkyl or hydroxyalkyl of 1-3 carbon atoms or a mixture thereof; R² and R³ can be attached to each other, e.g. through an oxygen or nitrogen atom, to form a ring structure; R⁴ is an alkaline or a hydroxyalkylene group containing 2 to 3 carbon atoms; and n ranges from 0 to about 20.

Useful water soluble amine oxide surfactants are selected from the coconut or tallow alkyl di-(lower alkyl) amine oxides, specific examples of which are dodecyldimethylamine oxide, tridecyldimethylamine oxide, etradecyldimethylamine oxide, pentadecyldimethylamine oxide, hexadecyldimethylamine oxide, heptadecyldimethylamine oxide, octadecyldimethylaine oxide, dodecyldipropylamine oxide, tetradecyldipropylamine oxide, hexadecyldipropylamine oxide, tetradecyldibutylamine oxide, octadecyldibutylamine oxide, bis(2-hydroxyethyl)dodecylamine oxide, bis(2-hydroxyethyl)-3-dodecoxy-1-hydroxypropylamine oxide, dimethyl-(2-hydroxydodecyl)amine oxide, 3,6,9-trioctadecyldimethylamine oxide and 3-dodecoxy-2-hydroxypropyldi-(2-hydroxyethyl)amine oxide.

Useful semi-polar nonionic surfactants also include the water soluble phosphine oxides having the following structure:

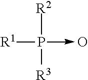

wherein the arrow is a conventional representation of a semi-polar bond; and, R¹ is an alkyl, alkenyl or hydroxyalkyl moiety ranging from 10 to about 24 carbon atoms in chain length; and, R² and R³ are each alkyl moieties separately selected from alkyl or hydroxyalkyl groups containing 1 to 3 carbon atoms.

Examples of useful phosphine oxides include dimethyldecylphosphine oxide, dimethyltetradecylphosphine oxide, methylethyltetradecylphosphone oxide, dimethylhexadecylphosphine oxide, diethyl-2-hydroxyoctyldecylphosphine oxide, bis(2-hydroxyethyl)dodecylphosphine oxide, and bis(hydroxymethyl)tetradecylphosphine oxide.

Semi-polar nonionic surfactants useful herein also include the water soluble sulfoxide compounds which have the structure:

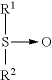

wherein the arrow is a conventional representation of a semi-polar bond; and, R¹ is an alkyl or hydroxyalkyl moiety of about 8 to about 28 carbon atoms, from 0 to about 5 ether linkages and from 0 to about 2 hydroxyl substituents; and R² is an alkyl moiety consisting of alkyl and hydroxyalkyl groups having 1 to 3 carbon atoms.

Useful examples of these sulfoxides include dodecyl methyl sulfoxide; 3-hydroxy tridecyl methyl sulfoxide; 3-methoxy tridecyl methyl sulfoxide; and 3-hydroxy-4-dodecoxybutyl methyl sulfoxide.

Semi-polar nonionic surfactants for the compositions of the invention include dimethyl amine oxides, such as lauryl dimethyl amine oxide, myristyl dimethyl amine oxide, cetyl dimethyl amine oxide, combinations thereof, and the like. Useful water soluble amine oxide surfactants are selected from the octyl, decyl, dodecyl, isododecyl, coconut, or tallow alkyl di-(lower alkyl) amine oxides, specific examples of which are octyldimethylamine oxide, nonyldimethylamine oxide, decyldimethylamine oxide, undecyldimethylamine oxide, dodecyldimethylamine oxide, iso-dodecyldimethyl amine oxide, tridecyldimethylamine oxide, tetradecyldimethylamine oxide, pentadecyldimethylamine oxide, hexadecyldimethylamine oxide, heptadecyldimethylamine oxide, octadecyldimethylaine oxide, dodecyldipropylamine oxide, tetradecyldipropylamine oxide, hexadecyldipropylamine oxide, tetradecyldibutylamine oxide, octadecyldibutylamine oxide, bis(2-hydroxyethyl)dodecylamine oxide, bis(2-hydroxyethyl)-3-dodecoxy-1-hydroxypropylamine oxide, dimethyl-(2-hydroxydodecyl)amine oxide, 3,6,9-trioctadecyldimethylamine oxide and 3-dodecoxy-2-hydroxypropyldi-(2-hydroxyethyl)amine oxide.

Suitable nonionic surfactants suitable for use with the compositions of the present invention include alkoxylated surfactants. Suitable alkoxylated surfactants include EO/PO copolymers, capped EO/PO copolymers, alcohol alkoxylates, capped alcohol alkoxylates, mixtures thereof, or the like. Suitable alkoxylated surfactants for use as solvents include EO/PO block copolymers, such as the Pluronic® and reverse Pluronic® surfactants; alcohol alkoxylates, such as Dehypon® LS-54 (R-(EO)₅(PO)₄) and Dehypon® LS-36 (R-(EO)₃(PO)₆); and capped alcohol alkoxylates, such as Plurafac® LF221 and Tegoten® EC11; mixtures thereof, or the like.

An effective amount of the nonionic surfactant is provided in combination with the quaternary ammonium compound and anionic surfactant including between about 1 wt-% to about 50 wt-%, about 1 wt-% to about 45 wt-%, about 1 wt-% to about 40 wt-%, about 1 wt-% to about 35 wt-%, about 1 wt-% to about 30 wt-%, about 1 wt-% to about 25 wt-%, about 1-wt-% to about 20 wt-%, about 1 wt-% to about 15 wt-%, or about 1 wt-% to about 10 wt-%. Without being limited according to the invention, all ranges recited are inclusive of the numbers defining the range and include each integer within the defined range.

An effective amount of the nonionic surfactant is provided in combination with the quaternary ammonium compound and anionic surfactant. Suitable concentrations of the nonionic surfactant in a use solution for non-antimicrobial compositions include between about 0.1 ppm and about 1,000 ppm, about 1 ppm and about 500 ppm, about 1 ppm and about 200 ppm, about 1 ppm and about 150 ppm, about 5 ppm and about 150 ppm, about 5 ppm and about 100 ppm. Without being limited according to the invention, all ranges recited are inclusive of the numbers defining the range and include each integer within the defined range.

Additional Functional Ingredients

The components of the compositions can further be combined with various functional components. In some embodiments, the compositions including the quaternary ammonium compounds and anionic surfactants make up a large amount, or even substantially all of the total weight of the composition. For example, in some embodiments few or no additional functional ingredients are disposed therein. In other embodiments, additional functional ingredients may be included in the compositions. The functional ingredients provide desired properties and functionalities to the compositions. For the purpose of this application, the term “functional ingredient” includes a material that when dispersed or dissolved in the aqueous use solution provides a beneficial property in a particular use. Some particular examples of functional materials are discussed in more detail below, although the particular materials discussed are given by way of example only, and that a broad variety of other functional ingredients may be used.

In some embodiments, the compositions may include additional functional ingredients including, for example, additional surfactants, including nonionic surfactants, thickeners and/or viscosity modifiers, solvents, solubility modifiers, humectants, metal protecting agents, stabilizing agents, corrosion inhibitors, additional sequestrants and/or chelating agents, oxidizing agents, solidifying agent, sheeting agents, pH modifying components, including alkalinity and/or acidity sources, aesthetic enhancing agents (i.e., colorants, odorants, or perfumes), other cleaning agents, hydrotropes or couplers, buffers, and the like.

In some embodiments, the compositions do not include additional functional ingredients. In certain embodiments, the compositions do not include cationic surfactants. In certain embodiments, the compositions do not include viscoelasticity modifiers (or solubility modifiers or the like).

Alkalinity and/or Acidity Source

In some embodiments, the compositions can include a pH modifier to increase (e.g. strong acid or weak acid) or decrease (e.g. strong base or weak base) the pH of the compositions.

Stabilizing Agents

In some embodiments, the compositions of the present invention include dipicolinic acid as a stabilizing agent. Compositions including dipicolinic acid can be formulated to be free or substantially free of phosphorous. It has also been observed that the inclusion of dipicolinic acid in a composition of the present invention aids in achieving the phase stability of the compositions, compared to other conventional stabilizing agents, e.g., 1-hydroxy ethylidene-1,1-diphosphonic acid (CH₃C(PO₃H₂)₂OH) (HEDP). Additional suitable stabilizing agents include, for example, chelating agents or sequestrants. Suitable sequestrants include, but are not limited to, organic chelating compounds that sequester metal ions in solution, particularly transition metal ions. Such sequestrants include organic amino- or hydroxy-polyphosphonic acid complexing agents (either in acid or soluble salt forms), carboxylic acids (e.g., polymeric polycarboxylate), hydroxycarboxylic acids, aminocarboxylic acids, or heterocyclic carboxylic acids, e.g., pyridine-2, 6-dicarboxylic acid (dipicolinic acid).

In other embodiments, the sequestrant can be or include phosphonic acid or phosphonate salt. Suitable phosphonic acids and phosphonate salts include HEDP; ethylenediamine tetrakis methylenephosphonic acid (EDTMP); diethylenetriamine pentakis methylenephosphonic acid (DTPMP); cyclohexane-1,2-tetramethylene phosphonic acid; amino[tri(methylene phosphonic acid)]; (ethylene diamine[tetra methylene-phosphonic acid)]; 2-phosphene butane-1,2,4-tricarboxylic acid; or salts thereof, such as the alkali metal salts, ammonium salts, or alkyloyl amine salts, such as mono, di, or tetra-ethanolamine salts; picolinic, dipicolinic acid or mixtures thereof. In some embodiments, organic phosphonates, e.g, HEDP are included in the compositions of the present invention. Commercially available food additive chelating agents include phosphonates sold under the trade name DEQUEST® including, for example, 1-hydroxyethylidene-1, 1-diphosphonic acid, available from Monsanto Industrial Chemicals Co., St. Louis, Mo., as DEQUEST® 2010; amino(tri(methylenephosphonic acid)), (N[CH₂PO₃H₂]₃), available from Monsanto as DEQUEST® 2000; ethylenediamine[tetra(methylenephosphonic acid)] available from Monsanto as DEQUEST® 2041; and 2-phosphonobutane-1,2,4-tricarboxylic acid available from Mobay Chemical Corporation, Inorganic Chemicals Division, Pittsburgh, Pa., as Bayhibit AM.

The sequestrant can be or include aminocarboxylic acid type sequestrant. Suitable aminocarboxylic acid type sequestrants include the acids or alkali metal salts thereof, e.g., amino acetates and salts thereof. Suitable aminocarboxylates include N-hydroxyethylaminodiacetic acid; hydroxyethylenediaminetetraacetic acid, nitrilotriacetic acid (NTA); ethylenediaminetetraacetic acid (EDTA); N-hydroxyethyl-ethylenediaminetriacetic acid (HEDTA); diethylenetriaminepentaacetic acid (DTPA); and Alanine-N,N-diacetic acid; and the like; and mixtures thereof.

The sequestrant can be or include a polycarboxylate. Suitable polycarboxylates include, for example, polyacrylic acid, maleic/olefin copolymer, acrylic/maleic copolymer, polymethacrylic acid, acrylic acid-methacrylic acid copolymers, hydrolyzed polyacrylamide, hydrolyzed polymethacrylamide, hydrolyzed polyamide-methacrylamide copolymers, hydrolyzed polyacrylonitrile, hydrolyzed polymethacrylonitrile, hydrolyzed acrylonitrile-methacrylonitrile copolymers, polymaleic acid, polyfumaric acid, copolymers of acrylic and itaconic acid, phosphino polycarboxylate, acid or salt forms thereof, mixtures thereof, and the like.

In certain embodiments, the present composition includes about 0 wt-% to about 50 wt-% stabilizing agent, about 0 wt-% to about 20 wt-% stabilizing agent, about 0 wt-% to about 10 wt-% stabilizing agent, about 0.01 wt-% to about 10 wt-% stabilizing agent, about 0.4 wt-% to about 4 wt-% stabilizing agent, about 0.6 wt-% to about 3 wt-% stabilizing agent, about 1 wt-% to about 2 wt-% stabilizing agent. It is to be understood that all values and ranges within these values and ranges are encompassed by the present invention.

Thickening or Gelling Agents

The compositions of the present invention can include any of a variety of known thickeners. Suitable thickeners include natural gums such as xanthan gum, guar gum, or other gums from plant mucilage; polysaccharide based thickeners, such as alginates, starches, and cellulosic polymers (e.g., carboxymethyl cellulose); polyacrylates thickeners; and hydrocolloid thickeners, such as pectin. In an embodiment, the thickener does not leave contaminating residue on the surface of an object. For example, the thickeners or gelling agents can be compatible with food or other sensitive products in contact areas. Generally, the concentration of thickener employed in the present compositions or methods will be dictated by the desired viscosity within the final composition. However, as a general guideline, the viscosity of thickener within the present composition ranges from about 0.1 wt-% to about 5 wt-%, from about 0.1 wt-% to about 1.0 wt-%, or from about 0.1 wt-% to about 0.5 wt-%.

Sequestrants

The composition can contain an organic or inorganic sequestrant or mixtures of sequestrants. Organic sequestrants such as sodium citrate, the alkali metal salts of nitrilotriacetic acid (NTA), dicarboxymethyl glutamic acid tetrasodium salt (GLDA), EDTA, alkali metal gluconates, polyelectrolytes such as a polyacrylic acid, and the like can be used herein. The most preferred sequestrants are organic sequestrants such as sodium gluconate due to the compatibility of the sequestrant with the formulation base.

The present invention can also incorporate sequestrants to include materials such as, complex phosphate sequestrants, including sodium tripolyphosphate, sodium hexametaphosphate, and the like, as well as mixtures thereof. Phosphates, the sodium condensed phosphate hardness sequestering agent component functions as a water softener, a cleaner, and a detergent builder. Alkali metal (M) linear and cyclic condensed phosphates commonly have a M₂O:P₂O₅ mole ratio of about 1:1 to 2:1 and greater. Typical polyphosphates of this kind are the preferred sodium tripolyphosphate, sodium hexametaphosphate, sodium metaphosphate as well as corresponding potassium salts of these phosphates and mixtures thereof. The particle size of the phosphate is not critical, and any finely divided or granular commercially available product can be employed.

Metal Protectors

The compositions of the invention can contain a material that can protect metal from corrosion. Such metal protectors include for example sodium gluconate and sodium glucoheptonate. If present, the metal protector is present in the composition in an amount of from about 0.1 wt-% to about 10 wt-%.

Solidification Agents

If it is desirous to prepare compositions of the invention as a solid, a solidification agent may be included into the composition. In some embodiments, the solidification agent can form and/or maintain the composition as a solid. In other embodiments, the solidification agent can solidify the composition without unacceptably detracting from the eventual release of the active ingredients. The solidification agent can include, for example, an organic or inorganic solid compound having a neutral inert character or making a functional, stabilizing or detersive contribution to the present composition. Suitable solidification agents include solid polyethylene glycol (PEG), solid polypropylene glycol, solid EO/PO block copolymer, amide, urea (also known as carbamide), nonionic surfactant (which can be employed with a coupler), anionic surfactant, starch that has been made water-soluble (e.g., through an acid or alkaline treatment process), cellulose that has been made water-soluble, inorganic agent, poly(maleic anhydride/methyl vinyl ether), polymethacrylic acid, other generally functional or inert materials with high melting points, mixtures thereof, and the like;

Suitable glycol solidification agents include a solid polyethylene glycol or a solid polypropylene glycol, which can, for example, have molecular weight of about 1,400 to about 30,000. In certain embodiments, the solidification agent includes or is solid PEG, for example PEG 1500 up to PEG 20,000. In certain embodiments, the PEG includes PEG 1450, PEG 3350, PEG 4500, PEG 8000, PEG 20,000, and the like. Suitable solid polyethylene glycols are commercially available from Union Carbide under the tradename CARBOWAX.

Suitable amide solidification agents include stearic monoethanolamide, lauric diethanolamide, stearic diethanolamide, stearic monoethanol amide, cocodiethylene amide, an alkylamide, mixtures thereof, and the like. In an embodiment, the present composition can include glycol (e.g., PEG) and amide.

Suitable nonionic surfactant solidification agents include nonylphenol ethoxylate, linear alkyl alcohol ethoxylate, ethylene oxide/propylene oxide block copolymer, mixtures thereof, or the like. Suitable ethylene oxide/propylene oxide block copolymers include those sold under the Pluronic tradename (e.g., Pluronic 108 and Pluronic F68) and commercially available from BASF Corporation. In some embodiments, the nonionic surfactant can be selected to be solid at room temperature or the temperature at which the composition will be stored or used. In other embodiments, the nonionic surfactant can be selected to have reduced aqueous solubility in combination with the coupling agent. Suitable couplers that can be employed with the nonionic surfactant solidification agent include propylene glycol, polyethylene glycol, mixtures thereof, or the like.

Suitable anionic surfactant solidification agents include linear alkyl benzene sulfonate, alcohol sulfate, alcohol ether sulfate, alpha olefin sulfonate, mixtures thereof, and the like. In an embodiment, the anionic surfactant solidification agent is or includes linear alkyl benzene sulfonate. In an embodiment, the anionic surfactant can be selected to be solid at room temperature or the temperature at which the composition will be stored or used. One skilled in the art will recognize that if an sulfonated or sulfate anionic surfactant is used to prepare a solid composition of the invention, the amount of anionic surfactant included as the solidification agent is above and beyond that used to minimize the antimicrobial activity of the quaternary ammonium.

Suitable inorganic solidification agents include phosphate salt (e.g., alkali metal phosphate), sulfate salt (e.g., magnesium sulfate, sodium sulfate or sodium bisulfate), acetate salt (e.g., anhydrous sodium acetate), Borates (e.g., sodium borate), Silicates (e.g., the precipitated or fumed forms (e.g., Sipernat 50® available from Degussa), carbonate salt (e.g., calcium carbonate or carbonate hydrate), other known hydratable compounds, mixtures thereof, and the like. In an embodiment, the inorganic solidification agent can include organic phosphonate compound and carbonate salt, such as an E-Form composition.

In some embodiments, the compositions of the present invention can include any agent or combination of agents that provide a requisite degree of solidification and aqueous solubility can be included in the present compositions. In other embodiments, increasing the concentration of the solidification agent in the present composition can tend to increase the hardness of the composition. In yet other embodiments, decreasing the concentration of solidification agent can tend to loosen or soften the concentrate composition.

In some embodiments, the solidification agent can include any organic or inorganic compound that imparts a solid character to and/or controls the soluble character of the present composition, for example, when placed in an aqueous environment. For example, a solidifying agent can provide controlled dispensing if it has greater aqueous solubility compared to other ingredients in the composition. Urea can be one such solidification agent. By way of further example, for systems that can benefit from less aqueous solubility or a slower rate of dissolution, an organic nonionic or amide hardening agent may be appropriate.

In some embodiments, the compositions of the present invention can include a solidification agent that provides for convenient processing or manufacture of the present composition. For example, the solidification agent can be selected to form a composition that can harden to a solid form under ambient temperatures of about 30 to about 50° C. after mixing ceases and the mixture is dispensed from the mixing system, within about 1 minute to about 3 hours, or about 2 minutes to about 2 hours, or about 5 minutes to about 1 hour.

The compositions of the present invention can include solidification agent at any effective amount. The amount of solidification agent included in the present composition can vary according to the type of composition, the ingredients of the composition, the intended use of the composition, the quantity of dispensing solution applied to the solid composition over time during use, the temperature of the dispensing solution, the hardness of the dispensing solution, the physical size of the solid composition, the concentration of the other ingredients, the concentration of the cleaning agent in the composition, and other like factors. Suitable amounts can include about 1 wt-% to about 99 wt-%, about 1.5 wt-% to about 85 wt-%, about 2 wt-% to about 80 wt-%, about 10 wt-% to about 45 wt-%, about 15 wt-% to about 40 wt-%, about 20 wt-% to about 30 wt-%, about 30 wt-% to about 70 wt-%, about 40 wt-% to about 60 wt-%, up to about 50 wt-%, about 40 wt-% to about 50 wt-%.

Dyes/Odorants

Various dyes, odorants including perfumes, and other aesthetic enhancing agents may also be included in the compositions. Examples of suitable commercially available dyes include, but are not limited to: Direct Blue 86, available from Mac Dye-Chem Industries, Ahmedabad, India; Fastusol Blue, available from Mobay Chemical Corporation, Pittsburgh, Pa.; Acid Orange 7, available from American Cyanamid Company, Wayne, N.J.; Basic Violet 10 and Sandolan Blue/Acid Blue 182, available from Sandoz, Princeton, N.J.; Acid Yellow 23, available from Chemos GmbH, Regenstauf, Germany; Acid Yellow 17, available from Sigma Chemical, St. Louis, Mo.; Sap Green and Metanil Yellow, available from Keystone Aniline and Chemical, Chicago, Ill.; Acid Blue 9, available from Emerald Hilton Davis, LLC, Cincinnati, Ohio; Hisol Fast Red and Fluorescein, available from Capitol Color and Chemical Company, Newark, N.J.; and Acid Green 25, Ciba Specialty Chemicals Corporation, Greenboro, N.C.

Examples of suitable fragrances or perfumes include, but are not limited to: terpenoids such as citronellol, aldehydes such as amyl cinnamaldehyde, a jasmine such as C1S-jasmine or jasmal, and vanillin.

Additional Exemplary Antimicrobial Composition Embodiments

In some aspects, the antimicrobial compositions according to the invention may comprise, consist of and/or consist essentially of a quaternary ammonium compound in an amount from about 1 wt-% to about 75 wt-%, and an anionic surfactant in an amount from about 1 wt-% to about 50 wt-%.

In some aspects, the antimicrobial compositions according to the invention may comprise, consist of and/or consist essentially of a quaternary ammonium compound in an amount from about 1 wt-% to about 75 wt-%, an anionic surfactant in an amount from about 1 wt-% to about 50 wt-%, and at least one additional functional ingredient selected from the group consisting of: additional surfactant, thickeners and/or viscosity modifiers, solvent, metal protecting agents, stabilizing agents, corrosion inhibitors, additional sequestrants and/or chelating agents, oxidizing agents, solidifying agent, sheeting agents, pH modifying components, aesthetic enhancing agents, other cleaning agents, hydrotropes or couplers, and emollient in an amount from about 0.01 wt-% to about 50 wt-%.

In some aspects, the antimicrobial compositions according to the invention may comprise, consist of and/or consist essentially of a quaternary ammonium compound in an amount from about 1 wt-% to about 75 wt-%, an anionic surfactant in an amount from about 1 wt-% to about 50 wt-%, and at least two additional functional ingredients selected from the group consisting of: additional surfactant, thickeners and/or viscosity modifiers, solvent, metal protecting agents, stabilizing agents, corrosion inhibitors, additional sequestrants and/or chelating agents, oxidizing agents, solidifying agent, sheeting agents, pH modifying components, aesthetic enhancing agents, other cleaning agents, hydrotropes or couplers, and emollient in an amount from about 0.01 wt-% to about 50 wt-%.

In some aspects, the antimicrobial compositions according to the invention may comprise, consist of and/or consist essentially of a quaternary ammonium compound in an amount from about 1 wt-% to about 75 wt-%, an anionic surfactant in an amount from about 1 wt-% to about 50 wt-%, and at least three additional functional ingredients selected from the group consisting of: additional surfactant, thickeners and/or viscosity modifiers, solvent, metal protecting agents, stabilizing agents, corrosion inhibitors, additional sequestrants and/or chelating agents, oxidizing agents, solidifying agent, sheeting agents, pH modifying components, aesthetic enhancing agents, other cleaning agents, hydrotropes or couplers, and emollient in an amount from about 0.01 wt-% to about 50 wt-%.

Additional Exemplary Non-Antimicrobial Composition Embodiments

In some aspects, the antimicrobial compositions according to the invention may comprise, consist of and/or consist essentially of a quaternary ammonium compound in an amount from about 1 wt-% to about 75 wt-%, an anionic surfactant in an amount from about 1 wt-% to about 50 wt-%, and a nonionic surfactant in an amount from about 1 wt-% to about 60 wt-%.

In some aspects, the antimicrobial compositions according to the invention may comprise, consist of and/or consist essentially of a quaternary ammonium compound in an amount from about 1 wt-% to about 75 wt-%, an anionic surfactant in an amount from about 1 wt-% to about 50 wt-%, a nonionic surfactant in an amount from about 1 wt-% to about 60 wt-%, and at least one additional functional ingredient selected from the group consisting of: additional surfactant, thickeners and/or viscosity modifiers, solvent, metal protecting agents, stabilizing agents, corrosion inhibitors, additional sequestrants and/or chelating agents, oxidizing agents, solidifying agent, sheeting agents, pH modifying components, aesthetic enhancing agents, other cleaning agents, hydrotropes or couplers, and emollient in an amount from about 0.01 wt-% to about 50 wt-%.

In some aspects, the antimicrobial compositions according to the invention may comprise, consist of and/or consist essentially of a quaternary ammonium compound in an amount from about 1 wt-% to about 75 wt-%, an anionic surfactant in an amount from about 1 wt-% to about 50 wt-%, a nonionic surfactant in an amount from about 1 wt-% to about 60 wt-%, and at least two additional functional ingredient selected from the group consisting of: additional surfactant, thickeners and/or viscosity modifiers, solvent, metal protecting agents, stabilizing agents, corrosion inhibitors, additional sequestrants and/or chelating agents, oxidizing agents, solidifying agent, sheeting agents, pH modifying components, aesthetic enhancing agents, other cleaning agents, hydrotropes or couplers, and emollient in an amount from about 0.01 wt-% to about 50 wt-%.

In some aspects, the antimicrobial compositions according to the invention may comprise, consist of and/or consist essentially of a quaternary ammonium compound in an amount from about 1 wt-% to about 75 wt-%, an anionic surfactant in an amount from about 1 wt-% to about 50 wt-%, a nonionic surfactant in an amount from about 1 wt-% to about 60 wt-%, and at least three additional functional ingredient selected from the group consisting of: additional surfactant, thickeners and/or viscosity modifiers, solvent, metal protecting agents, stabilizing agents, corrosion inhibitors, additional sequestrants and/or chelating agents, oxidizing agents, solidifying agent, sheeting agents, pH modifying components, aesthetic enhancing agents, other cleaning agents, hydrotropes or couplers, and emollient in an amount from about 0.01 wt-% to about 50 wt-%.

Use Compositions

The compositions may include concentrate compositions or may be diluted to form use compositions. In general, a concentrate refers to a composition that is intended to be diluted with water to provide a use solution that contacts a surface and/or product in need of treatment to provide the desired rinsing, sanitizing or the like. The compositions that contact the surface and/or product in need of treatment can be referred to as a concentrate or a use composition (or use solution) dependent upon the formulation employed in methods according to the invention. It should be understood that the concentration of the quaternary ammonium compound and anionic surfactants (and nonionic surfactants for non-antimicrobial compositions) in the composition will vary depending on whether the composition is provided as a concentrate or as a use solution.

A use solution may be prepared from the concentrate by diluting the concentrate with water at a dilution ratio that provides a use solution having desired sanitizing and/or other antimicrobial properties. The water that is used to dilute the concentrate to form the use composition can be referred to as water of dilution or a diluent, and can vary from one location to another. The typical dilution factor is between approximately 1 and approximately 10,000 but will depend on factors including water hardness, the amount of soil to be removed and the like. In an embodiment, the concentrate is diluted at a ratio of between about 1:10 and about 1:10,000 concentrate to water. Particularly, the concentrate is diluted at a ratio of between about 1:100 and about 1:5,000 concentrate to water. More particularly, the concentrate is diluted at a ratio of between about 1:250 and about 1:2,000 concentrate to water.

In preferred embodiments the present invention includes concentrate compositions and use compositions. In an embodiment, a concentrate composition can be diluted to a use solution before applying to an object. The concentrate can be marketed and an end user can dilute the concentrate with water or an aqueous diluent to a use solution. The level of active components in the concentrate composition is dependent on the intended dilution factor and the desired activity of the antimicrobial composition. Generally, a dilution of about 1 fluid ounce to about 10 gallons of water to about 10 fluid ounces to about 1 gallon of water is used for aqueous compositions of the present invention. In some embodiments, higher use dilutions can be employed if elevated use temperature (greater than 25° C.) or extended exposure time (greater than 30 seconds) can be employed. In the typical use locus, the concentrate is diluted with a major proportion of water using commonly available tap or service water mixing the materials at a dilution ratio of about 3 to about 40 ounces of concentrate per 100 gallons of water.

In some embodiments, the concentrated compositions can be diluted at a dilution ratio of about 0.1 g/L to about 100 g/L concentrate to diluent, about 0.5 g/L to about 10.0 g/L concentrate to diluent, about 1.0 g/L to about 4.0 g/L concentrate to diluent, or about 1.0 g/L to about 2.0 g/L concentrate to diluent.

In other embodiments, a use composition can include about 0.01 to about 10 wt-% of a concentrate composition and about 90 to about 99.99 wt-% diluent; or about 0.1 to about 1 wt-% of a concentrate composition and about 99 to about 99.9 wt-% diluent.

Amounts of an ingredient in a use composition can be calculated from the amounts listed above for concentrate compositions and these dilution factors. In some embodiments, the concentrated compositions of the present invention are diluted such that the quaternary ammonium component is present at from about 10 ppm to about 100 ppm, or about 20 ppm to about 80 ppm. In other embodiments, the concentrated compositions of the present invention are diluted such that the quaternary ammonium component is present at about 20 ppm or more, about 40 ppm or more, about 60 ppm or more, about 80 ppm or more, about 100 ppm or more, about 500 ppm, about 1000 ppm, or about 10,000 to about 20,000 ppm. It is to be understood that all values and ranges between these values and ranges are encompassed by the present invention.

Manufacturing Methods

Compositions of the present disclosure are prepared by simple addition of materials. The anionic surfactant is added to the quaternary ammonium. The quaternary ammonium compound readily couples the more hydrophobic organic acid into solution with minimal or no agitation. The addition of the nonionic surfactant for non-antimicrobial compositions results in micelle formation of the quaternary ammonium compounds.

In some aspects, the compositions according to the invention can be made by combining the components in an aqueous diluent using commonly available containers and blending apparatus. Beneficially, no special manufacturing equipment is required for making the compositions employing the quaternary ammonium compounds and the anionic surfactants. A preferred method for manufacturing the cleaning composition of the invention includes introducing the components into a stirred production vessel.

Methods of Use

The antimicrobial compositions according to the invention beneficially provide synergistic efficacy by formulating compositions comprising quaternary ammonium compounds and anionic surfactants. Without being limited according to a particular mechanism of action according to the invention, the synergistic combination unexpectedly overcomes limitations of use of quaternary ammonium compounds as cleaning agents. The non-antimicrobial compositions formulated with a nonionic surfactant further provide soil removal efficacy with enhanced foaming stability.

The various methods of cleaning, soil removal, antimicrobial and/or foaming applications according to the disclosure can include the use of any suitable level of the quaternary ammonium compound and anionic surfactants. In some embodiments, the treated target composition comprises from about 1 ppm to about 5000 ppm of the quaternary ammonium compound when diluted for use. In further embodiments, the quaternary ammonium compound in a use solution for antimicrobial compositions include between about 1 ppm and about 5000 ppm, between about 100 ppm and about 4000 ppm, between about 100 ppm and about 2500 ppm, between about 100 ppm and about 1500 ppm or between about 500 ppm and about 1500 ppm. In non-antimicrobial applications, the quaternary ammonium compound in a use solution can include between about 0.1 ppm and about 500 ppm, between about 1 ppm and about 100 ppm, between about 1 ppm and about 75 ppm, between about 5 ppm and about 75 ppm, or between about 5 ppm and about 50 ppm. Without being limited according to the invention, all ranges recited are inclusive of the numbers defining the range and include each integer within the defined range.

In some embodiments, an effective amount of the anionic surfactant is provided in combination with the quaternary ammonium compound to provide antimicrobial efficacy or soil removal, including in a use solution at amounts between about 1 ppm and about 5,000 ppm, about 15 ppm and about 2,500 ppm, about 1 ppm and about 1,000 ppm, and preferably about 1 ppm and about 500 ppm. In other embodiments, the anionic surfactant in a use solution for non-antimicrobial compositions include between about 0.1 ppm and about 1000 ppm, between about 1 ppm and about 200 ppm, between about 1 ppm and about 150 ppm, between about 5 ppm and about 150 ppm, or between about 5 ppm and about 100 ppm. In such embodiments where the anionic surfactant is combined with a nonionic surfactant and the quaternary ammonium compound for non-antimicrobial applications of use, the nonionic surfactant can include between about 0.1 ppm and about 1,000 ppm, about 1 ppm and about 500 ppm, about 1 ppm and about 200 ppm, about 1 ppm and about 150 ppm, about 5 ppm and about 150 ppm, about 5 ppm and about 100 ppm. Without being limited according to the invention, all ranges recited are inclusive of the numbers defining the range and include each integer within the defined range.

The various applications of use described herein provide the quaternary ammonium compound and anionic surfactant and optionally nonionic surfactant compositions to a surface and/or product in need of cleaning, soil removal, anti-microbial and/or foaming soil removal. Beneficially, the compositions of the invention are fast-acting. However, the present methods require a certain minimal contact time of the compositions with the surface or product in need of treatment for occurrence of sufficient antimicrobial effect. The contact time can vary with concentration of the use compositions, method of applying the use compositions, temperature of the use compositions, pH of the use compositions, amount of the surface or product to be treated, amount of soil or substrates on/in the surface or product to be treated, or the like. The contact or exposure time can be about 15 seconds, at least about 15 seconds, about 30 seconds or greater than 30 seconds. In some embodiments, the exposure time is about 1 to 5 minutes. In other embodiments, the exposure time is at least about 10 minutes, 30 minutes, or 60 minutes. In other embodiments, the exposure time is a few minutes to hours. The contact time will further vary based upon the concentration of peracid in a use solution.

In general, the cleaning methods according to the invention involve applying the liquid cleaning composition to a surface to be cleaned, allowing the composition to remain for a sufficient period of time for cleaning (typically until any foam that is present dissipates) and thereafter rinsing said surface until that said cleaning composition is removed along with soil and debris. The surface to be cleaned can include for examples skin, namely hands of a person in need of washing thereof. In a further aspect, the surface to be cleaned can include ware.

The present methods can be conducted at any suitable temperature. In some embodiments, the present methods are conducted at a temperature ranging from about 0° C. to about 5° C., e.g., from about 5° C. to about 10° C., 0° C. to about 10° C., 0° C. to about 20° C., 0° C. to about 40° C., 0° C. to about 50° C., 0° C. to about 70° C., or at increased temperatures there above suitable for a particular application of use.

Beneficially, the compositions are suitable for antimicrobial efficacy against a broad spectrum of microorganisms, providing broad spectrum bactericidal and fungistatic activity. For example, the of this invention provide broad spectrum activity against wide range of different types of microorganisms (including both aerobic and anaerobic microorganisms, gram positive and gram negative microorganisms), including bacteria, yeasts, molds, fungi, algae, and other problematic microorganisms.

The present methods can be used to achieve any suitable reduction of the microbial population in and/or on the target or the treated target composition. In some embodiments, the present methods can be used to reduce the microbial population in and/or on the target or the treated target composition by at least one log 10. In other embodiments, the present methods can be used to reduce the microbial population in and/or on the target or the treated target composition by at least two log 10. In still other embodiments, the present methods can be used to reduce the microbial population in and/or on the target or the treated target composition by at least three log 10. In still other embodiments, the present methods can be used to reduce the microbial population in and/or on the target or the treated target composition by at least five log 10. Without limiting the scope of invention, the numeric ranges are inclusive of the numbers defining the range and include each integer within the defined range.

In an aspect, the methods of the invention include generating a use solution from the concentrated solid or liquid compositions of the invention. A use solution may be prepared from the concentrate by diluting the concentrate with water at a dilution ratio that provides a use solution having desired sanitizing and/or other antimicrobial properties. The water that is used to dilute the concentrate to form the use composition can be referred to as water of dilution or a diluent, and can vary from one location to another. The typical dilution factor is between approximately 1 and approximately 10,000. In an embodiment, the concentrate is diluted at a ratio of between about 1:10 and about 1:10,000 concentrate to water. Particularly, the concentrate is diluted at a ratio of between about 1:100 and about 1:5,000 concentrate to water. More particularly, the concentrate is diluted at a ratio of between about 1:250 and about 1:2,000 concentrate to water.

In an aspect, a concentrated composition is diluted from about 0.001% (wt/vol.) to about 10% (wt/vol.), or from about 0.001% (wt/vol.) to about 5% (wt/vol.), or from about 0.001% (wt/vol.) to about 2% (wt/vol.), or from about 0.01% (wt/vol.) to about 1% (wt/vol.). Without being limited to a particular dilution of the concentrated composition, in some aspects this dilution corresponds to approximately 0.1 mL to about 10 mL of the liquid concentrate per dish machine cycle (as one skilled in the art understands to further dependent on the rinse water volume of the dish machine). Without limiting the scope of invention, the numeric ranges are inclusive of the numbers defining the range and include each integer within the defined range.

Compositions of the invention can be formulated and sold for use as is, or as solvent or solid concentrates. If desired, such concentrates can be used full-strength as sanitizing rinse compositions. However, the concentrates typically will be diluted with a fluid (e.g., water) that subsequently forms the dilute phase or a use solution. Preferably, the concentrate forms a single phase before such dilution and remains so while stored in the container in which it will be sold. When combined with water or other desired diluting fluid at an appropriate dilution level and subjected to mild agitation (e.g., by stirring or pumping the composition), some compositions of the invention will form a pseudo-stable dispersion, and other compositions of the invention will form a clear or quasi-stable solution or dispersion. If a pseudo-stable composition is formed, then the composition preferably remains in the pseudo-stable state for a sufficiently long period so that the composition can be applied to a surface before the onset of phase separation. The pseudo-stable state need only last for a few seconds when suitably rapid application techniques such as spraying are employed, or when agitation during application is employed. The pseudo-stable state desirably lasts for at least one minute or more after mixing and while the composition is stored in a suitable vessel, and preferably lasts for five minutes or more after mixing. Often normal refilling or replenishment of the applicator (e.g., by dipping the applicator in the composition) will provide sufficient agitation to preserve the pseudo-stable state of the composition during application.

The compositions can be dosed into an application of use, or dispensed as the concentrate or use solution. The compositions can be diluted and dispensed from a dispenser mounted on or in the machine or from a separate dispenser that is mounted separately but cooperatively with the dish machine. For example, in some embodiments, liquid rinse agents can be dispensed by incorporating compatible packaging containing the liquid material into a dispenser adapted to diluting the liquid with water to a final use concentration. Some examples of dispensers for the liquid rinse agent of the invention are DRYMASTER-P sold by Ecolab Inc., St. Paul, Minn.

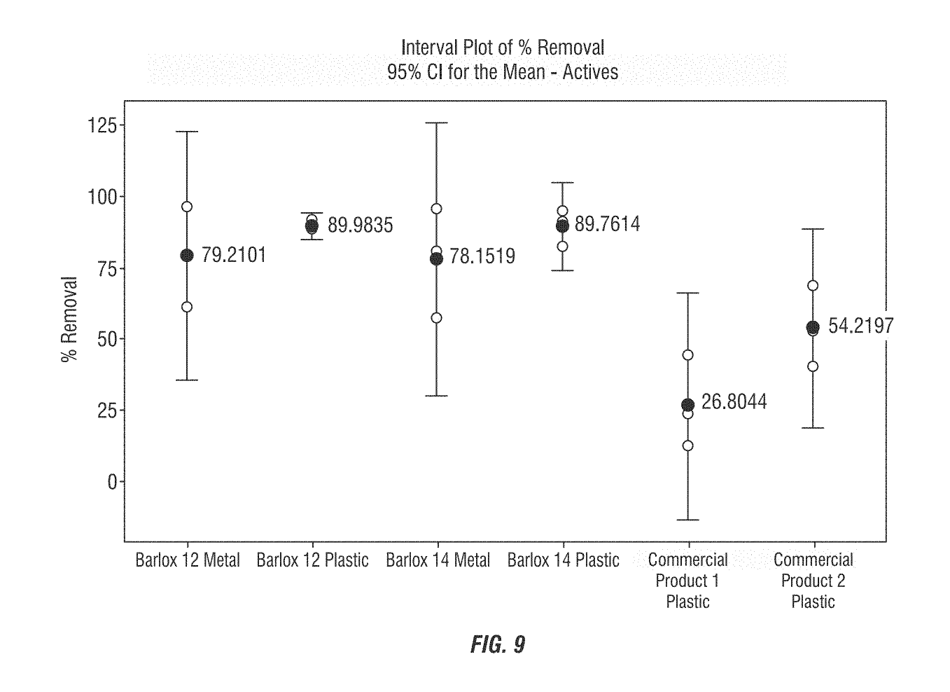

In other example embodiments, solid products may be conveniently dispensed by inserting a solid material in a container or with no enclosure into a spray-type dispenser such as the volume SOL-ET controlled ECOTEMP Rinse Injection Cylinder system manufactured by Ecolab Inc., St. Paul, Minn. Such a dispenser cooperates with a warewashing machine in the rinse cycle. When demanded by the machine, the dispenser directs a spray of water onto the cast solid block of rinse agent which effectively dissolves a portion of the block creating a concentrated aqueous rinse solution which is then fed directly into the rinse water forming the aqueous rinse. The aqueous rinse is then contacted with the dishes to affect a complete rinse. This dispenser and other similar dispensers are capable of controlling the effective concentration of the active portion in the aqueous rinse by measuring the volume of material dispensed, the actual concentration of the material in the rinse water (an electrolyte measured with an electrode) or by measuring the time of the spray on the cast block. In general, the concentration of active portion in the aqueous rinse is preferably the same as identified above for liquid rinse agents. Some other embodiments of spray-type dispenser are disclosed in U.S. Pat. Nos. 4,826,661, 4,690,305, 4,687,121, 4,426,362 and in U.S. Pat. Nos. Re 32,763 and 32,818, the disclosures of which are incorporated by reference herein. An example of a particular product shape is shown in FIG. 9 of U.S. Pat. No. 6,258,765, which is incorporated herein by reference.

Soaking Compositions

In one embodiment, the present invention is a foaming detergent composition which can be used as a soaking composition. The soaking composition and methods of using the soaking composition remove grease and food soils from surfaces without significant corrosive or detrimental effects on the aesthetics of such surfaces. In addition to loosening greasy, baked on soils, the soaking solution also protects the surface of the ware both while soaking in the soaking composition. The soaking composition is used to loosen grease and food soils on ware, such as pots and pans, before the pots and pans are run through a dishmachine. The soaking step reduces the number of washes soiled ware must undergo to remove the soils when compared to not using a soaking composition, soaking with water, or soaking with a manual detergent. The soaking composition can be used on ware made of various materials, including, for example: stainless steel, aluminum, cast iron and plastics. The soaking composition loosens grease and soil from the surface such that the soil is substantially removed from the surface when the ware is passed through a single cycle of a dishmachine. In addition, no personal protective equipment is needed when the soaking composition is used at the recommended concentration and with the recommended procedures.

Typically, when ware is soaked in a solution and then removed and placed into a dishmachine, a small quantity of the soaking solution is carried with the ware. Because the soaking composition is used prior to placing the ware in a dishmachine for cleaning, components in the soaking composition may produce foam. The soaking composition is formulated to produce lower foam than typical pot and pan detergents when agitated. However, beneficially according to the invention a stable foam is produced, including in the presence of food soils. As referred to herein, stable foam is a foam that remains for several minutes after agitation is stopped, in an aspect for at least 5 minutes, or at least 4 minutes, or at least 3 minutes, or at least 2 minutes, or at least 1 minute. A partially stable foam breaks slowly within a minute. An unstable foam breaks rapidly in less than 15 seconds. A antimicrobial hand soap should have stable foam.

Hand Soaps and Detergents

The composition according to the disclosure are further useful for hand soaps and detergents employing the quaternary ammonium compounds and anionic surfactant or anionic surfactant blend that provides a desired level of foaming and cleaning properties when diluted to a use solution.

In various embodiments of the invention the foaming cleaning compositions of the invention can advantageously be formulated to be cocamide DEA free, phosphate-free and/or aminocarboxylate-free, as well as containing only ingredients generally recognized as safe (GRAS) for human use.

A novel cleaning method is also within the invention and involves applying the foaming cleaning compositions described in the present disclosure to a surface to be cleaned, allowing the foam to remain for a sufficient period of time for cleaning (typically until the foam dissipates) and thereafter rinsing said surface to that said cleaning composition is removed along with soil and debris.

All publications and patent applications in this specification are indicative of the level of ordinary skill in the art to which this invention pertains. All publications and patent applications are herein incorporated by reference to the same extent as if each individual publication or patent application was specifically and individually indicated as incorporated by reference.

### EXAMPLES

Embodiments of the present invention are further defined in the following non-limiting Examples. It should be understood that these Examples, while indicating certain embodiments of the invention, are given by way of illustration only. From the above discussion and these Examples, one skilled in the art can ascertain the essential characteristics of this invention, and without departing from the spirit and scope thereof, can make various changes and modifications of the embodiments of the invention to adapt it to various usages and conditions. Thus, various modifications of the embodiments of the invention, in addition to those shown and described herein, will be apparent to those skilled in the art from the foregoing description. Such modifications are also intended to fall within the scope of the appended claims.

Materials used in the following Examples are provided herein:

Bardac 205M: a blend of Dialkyl/Alkyl Benzyl ammonium chloride

C25: coco-methyl (POE15) ammonium chloride

CC-42: Variquat CC 42 NS. The CAS Number for the actual compound is 68132-96-7, its Chemical Abstract name is Poly[oxy(methy-1,2-ethanediyl)], alpha-[2-diethylmethylammonio)ethyl]-omega-hydroxy chloride.

UniquatQAC50: an Alkyl Benzyl ammonium chloride

Barlox 12: cocoamine oxide surfactant

Barlox 14: myristyl amine oxide surfactant

Alpha olefin sulfonate (AOS)

Sodium lauryl sulfate (SLS)

Alkyl benzene sulfonate (LAS)

Sodium lauryl ether sulfate (SLES)

X-AES: extended chain anionic surfactant having the formula C₁₂₋₁₄—(PO)₁₆-(EO)₂-sulfate

Marlowet 4539: nonionic surfactant under acidic conditions, anionic under alkaline conditions, having the formula Iso C9-(PO)₂EO₂-carboxylic acid

### Example 1

Manual Foam Height Testing and Grease Removal was conducted to screen a manual pot and pan detergent's ability to remove grease and foam height and stability.

Grease Removal Test Procedure

Soil Formula:
85.5% Mazola Corn Oil (commercially available corn oil)
10% EcoSoya PB partially hydrogenated soy wax flakes
4.5% Preciral ATO 5

Materials:

Overhead mixer with ability to set rpm

Constant temperature water bath or heating chamber

1000 ml polypropylene breakers

Dish rack for drying

Equipment Setup:

1. The lightning rod mixers need to be calibrated to 210 rpm. The rpm are determined with a digital readout tachometer.

2. The blade of the mixer should be centered on the 250 ml line of the beaker.

Calculations:

$$\% Removal = \frac{Soil Removed \times 100}{Total Soil}$$

Procedure:

Mix and heat the above mixture until clear. Maintain the temperature between 154-162° F. (65-69° C.) with agitation until all beakers have been soiled. Temperature of the soil should not exceed 165° F. (74° C.). Soil (15 grams) is applied to 1000 ml polypropylene beakers which are then immersed in an ice bath. The soil solidifies and is held in the bath for five minutes. The soiled beaker is then stored at room temperature for 24 hours before performing the soil removal test. A test solution (500 ml) is heated to 105.8° F. (41° C.) in a heating chamber or water bath prior to running the removal test. The beaker is drained, held overnight in an inverted position and is reweighed. Place 500 mls of test solution in each beaker and agitate with overhead mixer set to 210 rpm for 15 minutes. After 15 minutes is complete, drain the test solution and place the beakers upside-down on a dish rack and allow to dry overnight. The next day, reweigh polypropylene beakers and calculate percent grease removal. A commercially available hand dish washing detergent can be used a control.

Equipment Setup for foam height:

Calibrate the Guwina-Hofmann rotation device to 30 rpm.

Procedure:

Forty milliliters of the aqueous test solution is placed in a 250 ml stoppered graduated cylinder and warmed to 110 F (about 43 C). The cylinder is rotated for 4 minutes by a Guwina-Hofmann rotation device and an initial foam height is measured in ml gradients. Two drops (approximately 0.05 g) of a liquefied soil containing 45% shortening, 30% flour, 15% powdered egg and 10% Mazola corn oil is added to the test solution, which is rotated for two minutes. This step is repeated until 45 ml or less foam results. The initial foam height, and the foam height after each addition of soil are summed to obtain a total foam height for the test. Each test is performed in triplicate, with an average foam height used to judge performance.

The following formulations were evaluated for foam height and grease removal and all tested at 1% active surfactants level:

Commercial Product 1: competitive detergent composition—solvents, sodium lauryl sulfate, sodium laureth sulfate, lauramine oxide, viscosity increasing agents, PEI/PEG copolymers, PEG propylheptyl ether, preservative, enzyme

Commercial Product 2: commercially-available detergent composition—solvents, polymeric quaternary ammonium compound (PEI), anionic surfactant, amine oxide

Base Nonionic Formulation: Glucopon (alkyl poly glucoside) and (Barlox) C12 amine oxide, included at about 1:1 ratio actives basis Anionic surfactants evaluated:

A-olefin sulfonate (AOS)

Sodium lauryl sulfate (SLS)

Alkyl benzene sulfonate (LAS)

Sodium lauryl ether sulfate (SLES)

Grease removal results. The grease removal of commercial products, a base nonionic formulation, and the base nonionic formulation with the addition of anionic surfactants were evaluated using various soils.

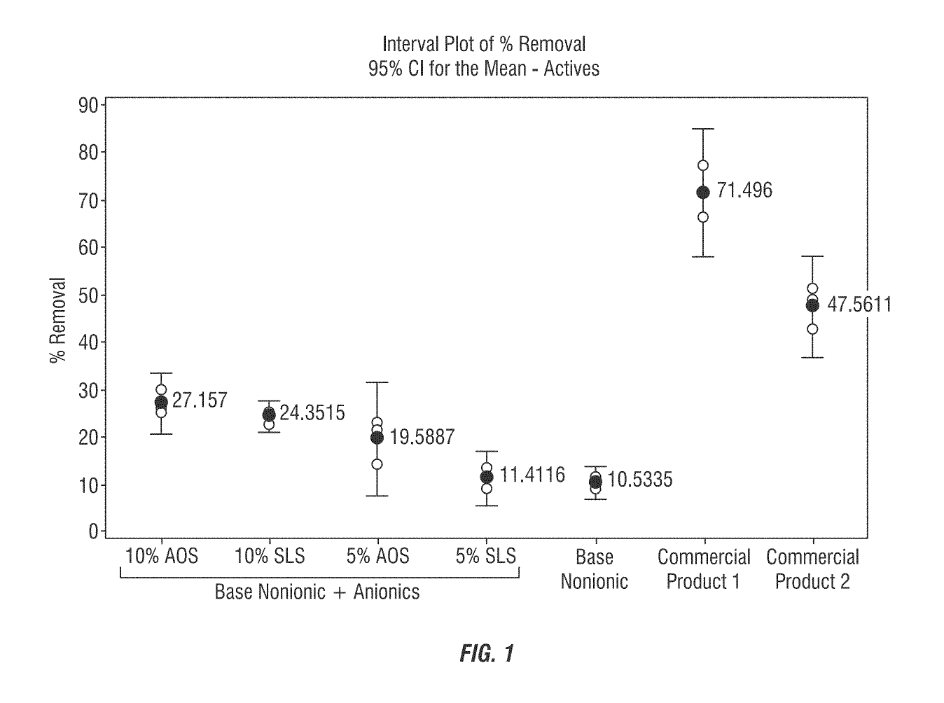

FIG. 1 shows testing with the EcoSoya PB (10%) soil solution in the beakers at a 1% active surfactant level. As shown the grease removal did not result in sufficient cleaning compared to commercial controls further containing the quaternary ammonium compounds. The base nonionics and anionic surfactant combination (without the addition of any quaternary ammonium compounds) did not outperform commercial products.

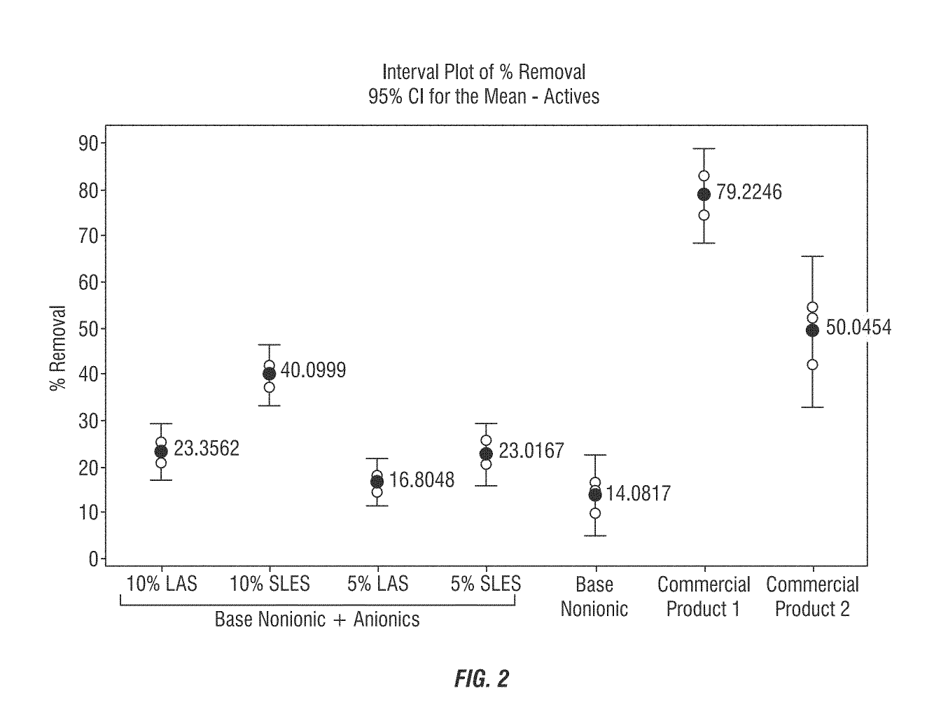

FIG. 2 shows additional testing with the EcoSoya PB (10%) soil solution in the beakers with distinct anionic surfactants evaluated in combination with the base nonionics at a 1% active surfactant level. Consistent with the data in FIG. 1, as shown the grease removal did not result in sufficient cleaning compared to commercial controls further containing the quaternary ammonium compounds. However, the evaluation of the combination of the base nonionic surfactant with 10% SLES provided improvement over other nonionic/anionic combinations.

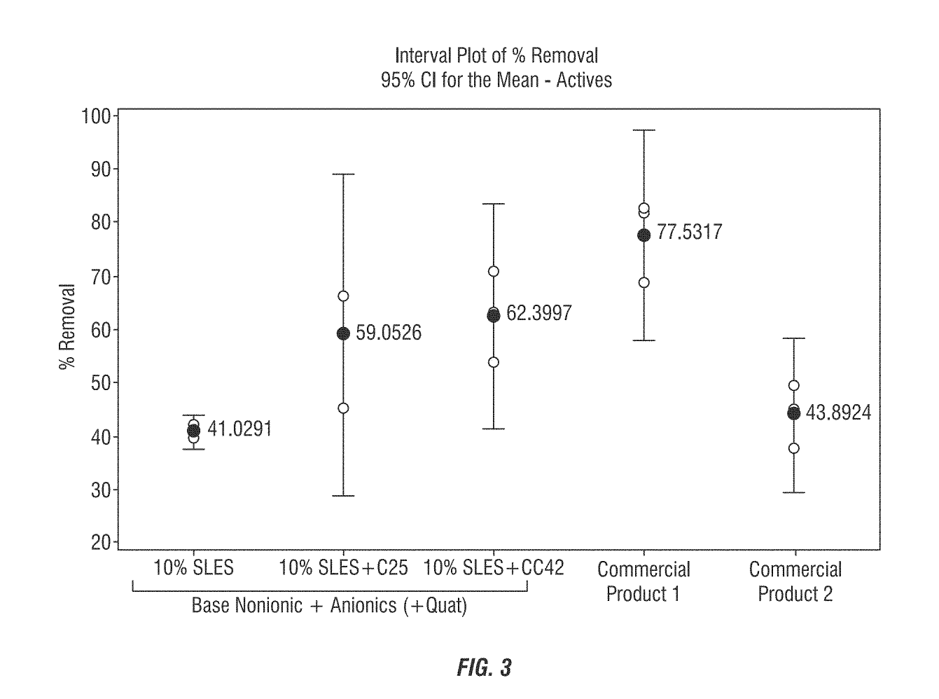

FIG. 3 shows testing with the EcoSoya PB (10%) soil solution in the beakers with two test solutions having the addition of a quaternary ammonium compound with the base nonionic and anionic surfactants. The addition of C₂₅ is an ethoxylated quaternary ammonium compound used in various cleaning formulations, and the CC42 is a propoxylated quaternary ammonium compound. As shown the grease removal was substantially improved with the addition of the quaternary ammonium compound in comparison to the results shown in FIGS. 1 and 2.

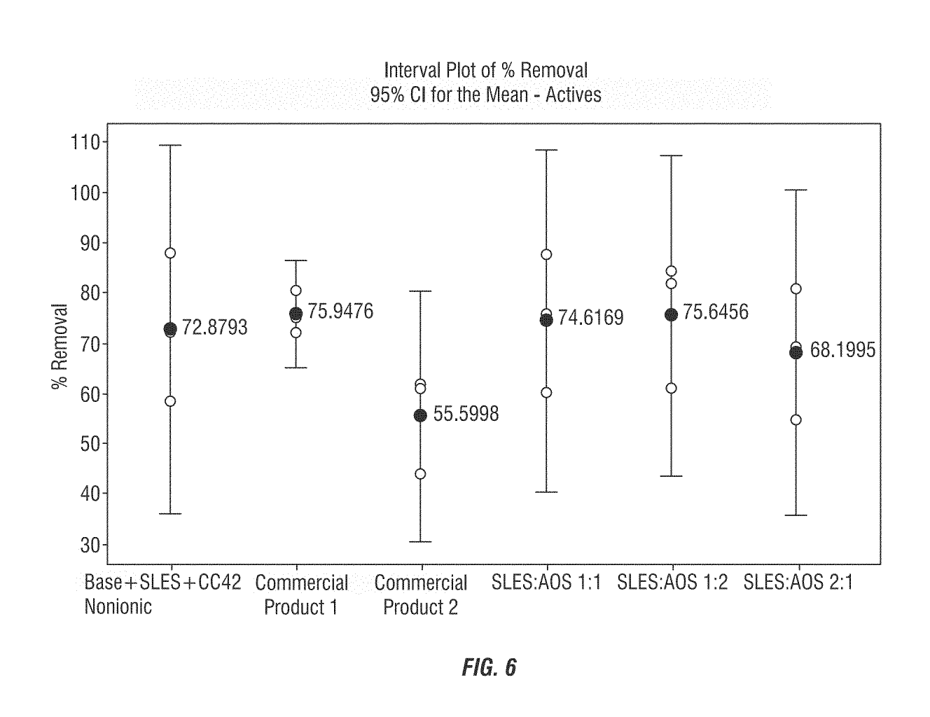

FIG. 6 shows still further testing with the EcoSoya PB (10%) soil solution in the beakers with various anionic surfactants evaluated in combination with the nonionic surfactant and quaternary ammonium compound, in comparison to the commercial controls. The graph shows the impact of increasing concentration of the anionic surfactant compared to the nonionic surfactant provides beneficially efficacy and further the systems perform well with the various anionic surfactants which beneficially provides flexibility in formulation of the compositions with anionic surfactant selection. The evaluated compositions in FIG. 6 further included C12 amine oxide (Barlox12) nonionic surfactant in the formulations.

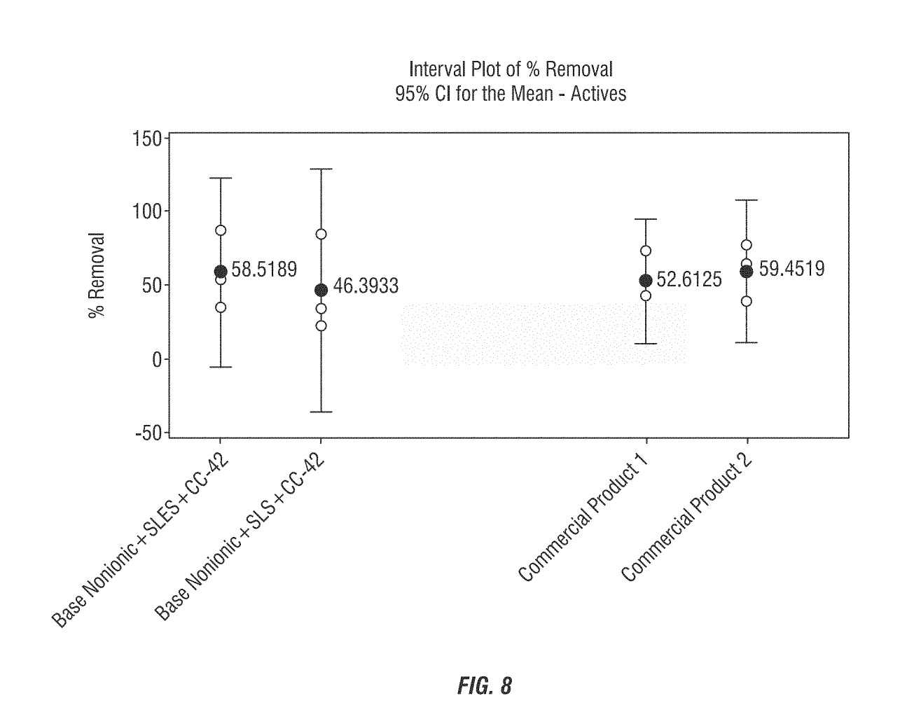

FIG. 8 shows still further testing with the EcoSoya PB (10%) soil solution in the beakers with various anionic surfactants evaluated in combination with the nonionic surfactant and quaternary ammonium compound, in comparison to the commercial controls. The graph shows the alkoxylated quaternary ammonium compound provides flexibility in the selection of the anionic surfactant while maintaining soil removal efficacy.

FIG. 9 shows still further testing with the EcoSoya PB (10%) soil solution in the beakers with various amine oxide surfactants evaluated in combination with the nonionic surfactant and quaternary ammonium compound, in comparison to the commercial controls. The graph shows the alkoxylated quaternary ammonium compound provides flexibility in the selection of the amine oxide surfactants (with efficacy of both C12 and C14 amine oxides) while maintaining soil removal efficacy that exceeds commercial controls.

Foam enhancement results demonstrating foam stabilization according to the invention.

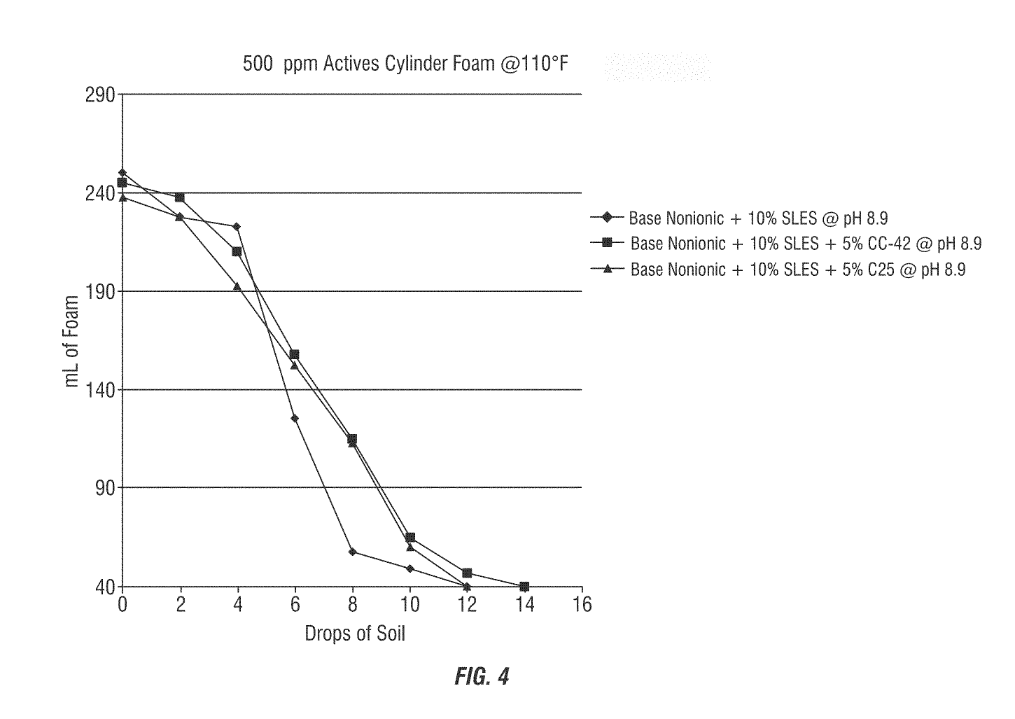

FIG. 4 shows the impact of the quaternary ammonium compounds on the boosting of foam resistance to soil with increasing concentration of soil at a pH of 8.9 at temperature of 110° F. in a Mazola soil evaluation. Beneficially, both quaternary ammonium compound containing formulations outperform the nonionic and anionic formulation demonstrating a significant boost in foam resistance to the soil.

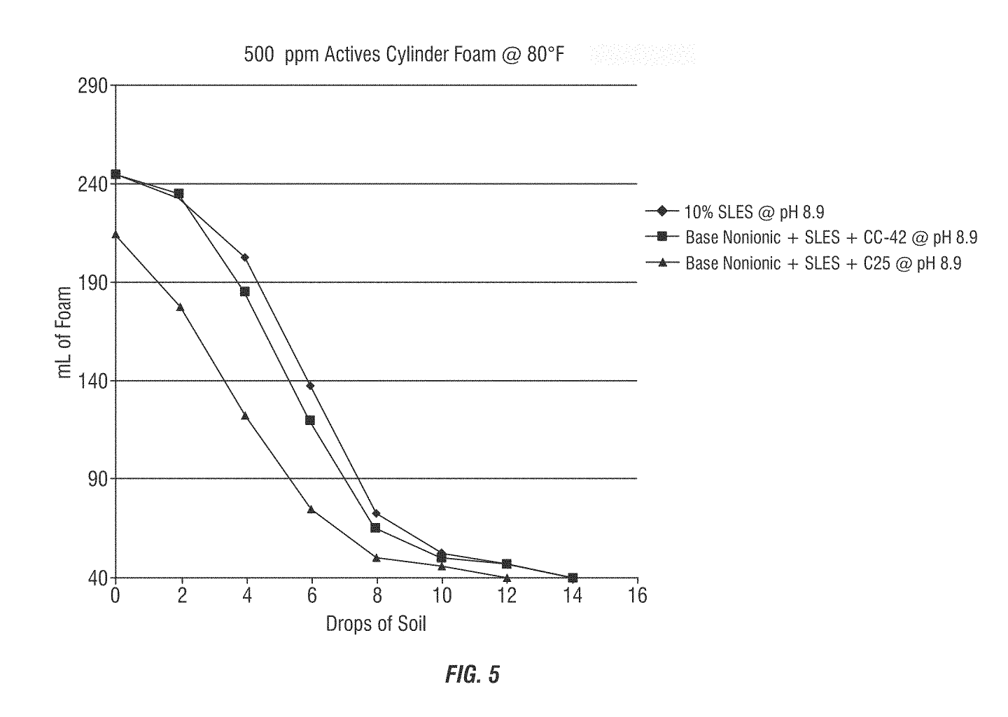

FIG. 5 shows the testing of the impact of the quaternary ammonium compounds on the impact of foam resistance to soil with increasing concentration of soil at a pH of 8.9 at room temperature in the same Mazola soil evaluation. At the room temperature conditions the propoxylated quaternary ammonium compound outperforms the ethoxylated quaternary ammonium compound, and shows the enhanced efficacy of the systems at higher temperatures.

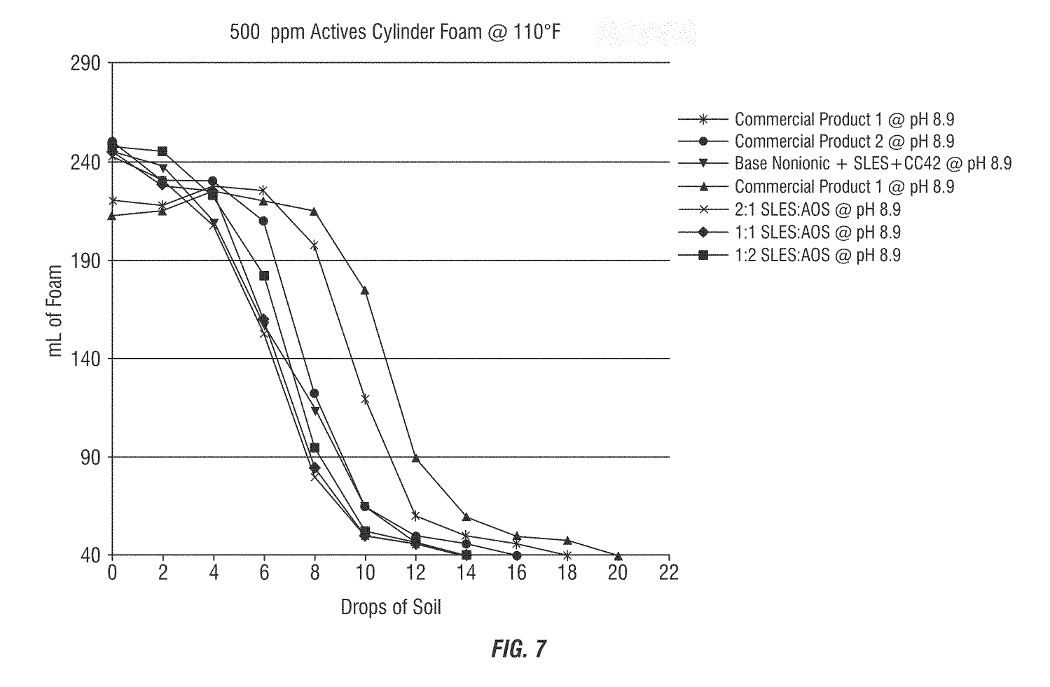

FIG. 7 shows the testing of the impact of the selection of anionic surfactant for use with the quaternary ammonium compounds and nonionic surfactant and the impact of foam resistance to soil with increasing concentration of soil at a pH of 8.9 at temperature of 110° F. in a Mazola soil evaluation. As depicted the alkoxylated quaternary ammonium compound provides flexibility in the selection of the anionic surfactant while maintaining foam resistance to soil.

### Example 2

Foam Evaluation of Bardac205M and Anionic Surfactants

A foam evaluation test was performed to assess the foam properties of 50 ppm Bardac 205M quaternary ammonium compound in combination with a number of anionic surfactants at a mole ratio to the quaternary ammonium compound. First, each quat was prepared and gently poured into a Glewwe cylinder. Samples tested contained a concentration of 50 ppm of the indicated antimicrobial quat. A ruler was attached to the side of the cylinder, and the solution was level with the bottom of the ruler. The pump was turned on. Foam height was estimated by reading the average level of foaming according to the ruler. Foam height readings were taken versus time with a stopwatch or timer. The pump was turned off and height of the foam was recorded at various times. Each sample was tested at 75° F., at a pressure of 6.0 psi. The foam level was read after 15 seconds of agitation and again after 60 seconds of agitation for a given amount of time. A stable foam is defined when the foam remains for several minutes after agitation is stopped. A partially stable foam breaks slowly within a minute. An unstable foam breaks rapidly in less than 15 seconds. A antimicrobial hand soap should have stable foam.

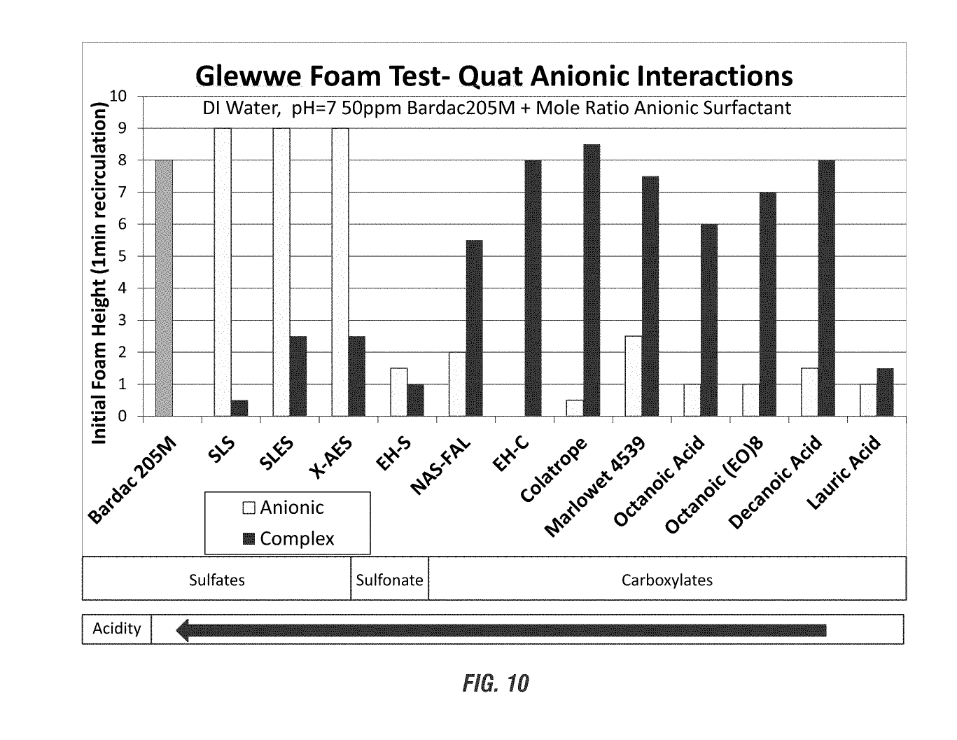

The results of this data are provided in FIG. 10 showing foam testing of Bardac 205M, different anionics, and molar combinations of Bardac 205M with the respective anionics. It is important to note that foam height alone does not tell the whole picture when considering foam properties. The foams provided by quat alone are “low quality” foams that are loose with large air pockets/cells that can break easily, while those of quat/anionic pairs are rich and of higher quality with tighter packing and smaller air pockets/cells that do not break as easily. The data further indicate that for the same alkyl hydrophobe, a quat/carboxylate pair provides better foam enhancement/stabilization than quat/sulfate or quat/sulfonate pairs. Without being bound by theory, it is believed that the “charge neutralization” of the quat/carboxylates are not as complete as that of the quat/sulfates and quat/sulfonates. Alternatively, the distance between the opposite quat and carboxylate charges are bigger than those between opposite quat and sulfate or sulfonates.

### Example 3

Cylinder Foam Test of UniQuat QAC50

A test was run to determine the foam profile of Uniquat QAC50 or Uniquat QAC50 Anionic surfactant pair at 500 ppm, following the procedure outlined in Example 2, with the addition of soils. The formulations evaluated are shown below:

Control: water zeolite softened 84.9 wt0%, Uniquat QAC-50 15 wt-%, remainder dye (7.5% actives).

Exp 1: water zeolite softened 83.5 wt-%, decanoic acid 1.5%, Uniquat QAC-50 15 wt-%, remainder dye (9% actives).

Exp 2: water zeolite softened 81.9 wt-%, colatrope INC 3%, Uniquat QAC-50 15 wt-%, remainder dye (10% actives).

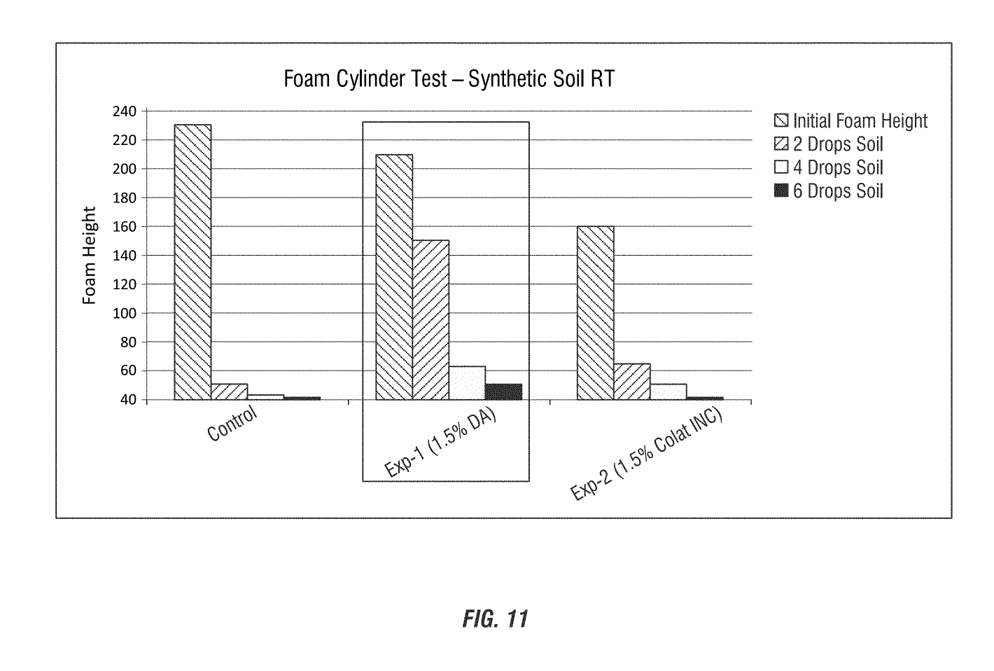

FIG. 11 summarizes the cylinder foam test results of the foamiest Quat, Uniquat QAC-50 (alkyl benzyl quat), vs. Uniquat QAC-50/Decanoate pair at aliquot addition of synthetic sebum soil. The total active surfactant concentration is 500 ppm in each case. This test simulates an antimicrobial hand soap/sanitizer application.

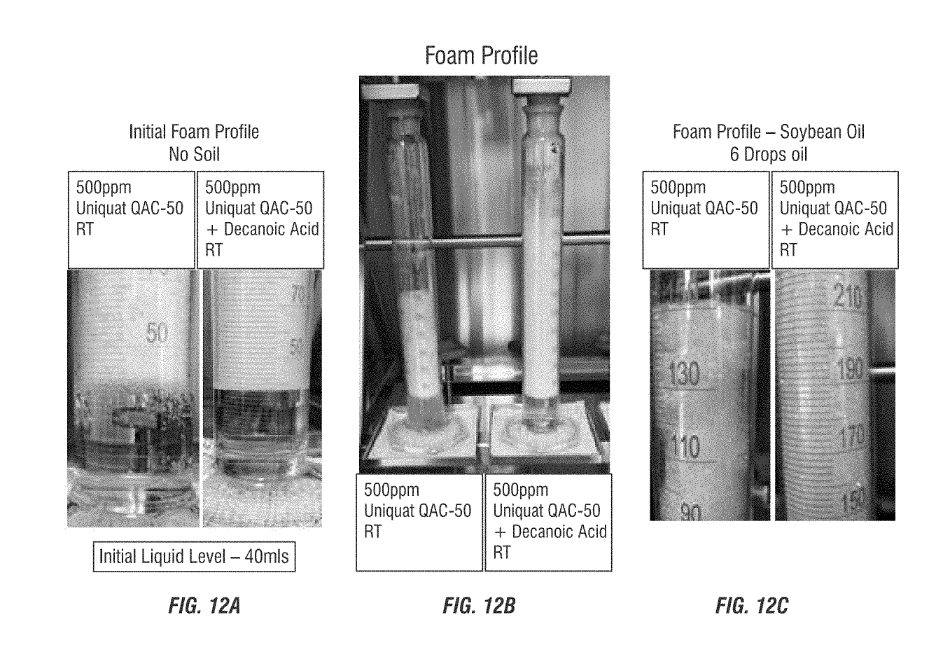

FIGS. 12A-12C show pictures taken during the testing to illustrate the foam qualities. The data illustrates the radically improved foam quality as well as foam tolerance to soil with the quat/carboxylate pair. These data suggest that Uniquat QAC50 in combination with Decanoic acid is particularly suitable to be used as an antimicrobial hand soap.

### Example 4

Additional compositions described according to embodiments of the invention at varying concentrations were mixed and the viscosity of the mixture was measured about 20 minutes later after mixing commenced using a Brookfield viscometer (model RVT or LVT) with spindle #2 at 50 rpm and at ambient (about 19° C.) as set forth in Tables 3A and 3B below. The protocol for measuring viscosity is set forth in detail in U.S. Pat. No. 9,309,485, the entire contents of which is herein incorporated by reference in its entirety. The total actives shown for the evaluated compositions are a combination of the four compounds of each formulation and an increasing active, to determine at which point the formulations become too viscous and no longer management by the quaternary ammonium/anionic surfactant combinations in the composition.

Table 3A shows formulations employing the combination of two non-ionic surfactants for foaming (APG/amine oxide), wherein the amine oxide is a C₁₂ amine oxide (Barlox12), anionic surfactant SSLES and the quaternary ammonium compound CC42 (propoxylated non antimicrobial quat). Table 3B shows the formulation of 3A with a modification to the amine oxide as a C₁₄ amine oxide (Barlox14). The increase in the chain length of the amine oxide automatically has increased viscoelasticity. The measurements for viscosity according to the Brookfield viscometer specifications are <1000 cps.

As shown, at increasing concentrations of the formulation compositions the quaternary ammonium compound CC42 has an increased role in maintaining viscosity. As the compositions with anionic/nonionic surfactant concentrations increase the viscosity will increase (ultimately becoming a paste where the composition is not manageable) which is primarily due to the surfactant concentration; however, beneficially according to the invention the quaternary ammonium compound reduces the propensity for the viscoelasticity. Accordingly, there is a benefit of a significant viscosity reduction, resulting in ability of highly concentrated formulations according to the present disclosure. In an aspect, detergents formulated with high level of anionic surfactants can become viscous, however the combination according to the present disclosure overcomes any gelling concerns and provides ease of manufacturing. Beneficially, the lowered viscosity also allows for the development of concentrated formulations.

TABLE 3A
Barlox 12

| | 5% | | 4% | | 3% | | 2% | | 1% |
|---|---|---|---|---|---|---|---|---|---|
| | CC-42 | | CC-42 | | CC-42 | | CC-42 | | CC-42 |
| 1X (24.5% | 101.6 | 1X | 63.2 | 1X | 74.0 | 1X | 85.2 | 1X | 165.6 |
| actives; base | | (23.5%) | | (22.5%) | | (20.5%) | | (19.5%) | |
| formula) | | | | | | | | | |
| 1.5X | 251.2 | 1.5X | 309.6 | 1.5X | 409.6 | 1.5X | paste | 1.5X | gel |
| (36.75%) | | (35.25%) | | (33.75%) | | (30.75%) | | (29.25%) | |
| 1.75X | 279.2 | 1.75X | 331.2 | 1.75X | 422.4 | 1.75X | paste | 1.75X | paste |
| (42.875%) | | (41.125%) | | (39.375%) | | (35.875%) | | (34.125%) | |
| 2X | not stable | 2X | | 2X | | 2X | | 2X | |
| (49%) | | (47%) | | (45%) | | (41%) | | (39%) | |

TABLE 3B
Barlox 14

| | 5% | | 4% | | 3% | | 2% | | 1% | | 0% |
|---|---|---|---|---|---|---|---|---|---|---|---|
| | CC-42 | | CC-42 | | CC-42 | | CC-42 | | CC-42 | | CC-42 |
| 1X | 68.0 | 1X | 76.8 | 1X | 92.4 | 1X | 132.0 | 1X | 211.2 | 1X | 756.0 |
| (24.5%) | | (23.5%) | | (22.5%) | | (21.5%) | | (20.5%) | | (19.5%) | |
| 1.5X | 248.8 | 1.5X | 316.8 | 1.5X | 453.1 | 1.5X | EEEE | 1.5X | | 1.5X | |
| (36.75%) | | (35.25%) | | (33.75%) | | (32.25%) | | (30.75%) | | (29.25%) | |
| 1.75X | 276.8 | 1.75X | 330.4 | 1.75X | 434.4 | 1.75X | | 1.75X | | 1.75X | |
| (42.875%) | | (41.125%) | | (39.375%) | | (37.625%) | | (35.875%) | | (34.125%) | |
| 2X | Not stable | 2X | | 2X | | 2X | | 2X | | 2X | |
| (49%) | | (47%) | | (45%) | | (43%) | | (41%) | | (39%) | |

EEE shown indicates the composition is too thick to measure.

Further evaluation of the non-propoxylated quaternary ammonium compounds ability to form the super concentrated compositions was compared to the propoxylated quaternary ammonium compounds of Tables 3A-3B. An ethoxylated C25 quaternary ammonium compound was formulated in combination with two non-ionic surfactants for foaming (APG/amine oxide), wherein the amine oxide is a C12 amine oxide (Barlox12), anionic surfactant SLES and the quaternary ammonium compound Ethoquad C25 (Cocoalkylmethyl[polyoxyethylene (15)] ammonium chloride). The measurements for viscosity according to the Brookfield viscometer specifications are not readable above the 1X composition as shown in Table 3C.

TABLE 3C

| | 5% Ethoquad C25 |
|---|---|
| 1X (24.5%) | 51.2 |
| 1.5X (36.75%) | paste |
| 1.75X (42.875%) | paste |
| 2X (49%) | paste |

This data further shows that the propoxylated quaternary ammonium compounds are superior to non-propoxylated quaternary ammonium compounds for maintaining viscosity and the resulting ability to form highly concentrated formulations according to the present disclosure. In an aspect, detergents formulated with high level of anionic surfactants can become viscous, however the combination employing a propoxylated quaternary ammonium compound according to the present disclosure overcomes any gelling concerns and provides ease of manufacturing. Beneficially, the lowered viscosity also allows for the development of concentrated formulations.

The inventions being thus described, it will be obvious that the same may be varied in many ways. Such variations are not to be regarded as a departure from the spirit and scope of the inventions and all such modifications are intended to be included within the scope of the following claims. The above specification provides a description of the manufacture and use of the disclosed compositions and methods. Since many embodiments can be made without departing from the spirit and scope of the invention, the invention resides in the claims.

What is claimed is:

1. An antimicrobial composition comprising:
a quaternary ammonium compound having the formula: 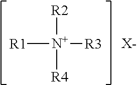
wherein groups R1, R2, R3, and R4 are independently selected from a C20 or less alkyl or alkoxy chain length, X— is an anion, and
an anionic surfactant having a C6-C18 chain length;
wherein the composition is a solid or liquid concentrate that is soluble in water, has a pH of about 1 to about 12 in a use solution, and provides at least a 3 log microbial kill on a treated surface.

2. The composition of claim 1, wherein the quaternary ammonium compound is selected from the group consisting of monoalkyltrimethyl ammonium salts, monoalkyldimethylbenzyl ammonium salts, dialkyldimethyl ammonium salts, heteroaromatic ammonium salts, polysubstituted quaternary ammonium salts, bis-quaternary ammonium salts, polymeric quaternary ammonium salts, and combinations thereof.

3. The composition of claim 1, wherein the quaternary ammonium has a carbon chain length of 8 to 20 carbon atoms and wherein the anionic surfactant is an alkoxylated or un-alkoxylated linear or branched chain carboxylate or an extended chain anionic surfactant.

4. The composition of claim 3, wherein the anionic surfactant is a C6-C10 medium chain length linear or branched chain carboxylate, or medium chain length linear or branched sulfate or sulfonate.

5. The composition of claim 1, wherein the anionic surfactant is a C8-C10 medium chain length linear or branched chain carboxylate, or medium chain length linear or branched sulfate or sulfonate.

6. The composition of claim 1, wherein the pH of the use solution is between about 6 and about 10, and in a use solution the composition provides from about 25 ppm to about 5000 ppm quaternary ammonium compound and from about 1 ppm and about 500 ppm anionic surfactant.

7. The composition of claim 1, further comprising an additional functional ingredient selected from the group consisting of additional surfactants, thickeners and/or viscosity modifiers, solvents, solubility modifiers, humectants, metal protecting agents, stabilizing agents, corrosion inhibitors, sequestrants and/or chelating agents, solidifying agent, sheeting agents, pH modifying components, fragrances and/or dyes, hydrotropes or couplers, buffers, and combinations thereof.

8. The composition of claim 1, wherein the concentrate is a liquid comprising from about 1 wt-% to about 30 wt-% anionic surfactant and from about 1 wt-% to about 75 wt-% quaternary ammonium compound.

9. A non-antimicrobial composition comprising:
a propoxylated quaternary ammonium compound having the formula: 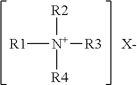
wherein groups R1, R2, R3 and R4 are independently selected from a C20 or less alkyl or alkoxy chain length, and wherein at least one of R1, R2, R3 and R4 is a propoxylated group, X— is an anion;
an anionic surfactant having a C6-C18 chain length;
at least one nonionic surfactant;
wherein the composition is a solid or liquid concentrate that is soluble in water at an actives level of at least 18% without the addition of a viscoelastic reducing agent, has a pH of about 1 to about 12 in a use solution, and provides enhanced soil removal with a stabilized foam in the presence of soil.

10. The composition of claim 9, wherein the concentrate composition has an actives level of at least about 30%.

11. The composition of claim 9, wherein the R4 group of the quaternary ammonium compound is a polyoxyalkylene chain of the formula
—CH₂—CH₂OC₃H₆ₙOH
wherein n is an integer from 10-50.

12. The composition of claim 9, wherein the quaternary ammonium compound has a formula of R1, R2 and R3 are independently (C₁-C₄ alkyl groups), R4 is a polyoxyalkylene chain, and X— comprises an anion.

13. The composition of claim 9, wherein the quaternary ammonium compound has a total molecular weight of propylene oxide of at least about 60%.

14. The composition of claim 9, wherein the anionic surfactant is comprised of sodium lauryl ether sulfate, sodium lauryl sulfate, alpha olefin sulfonate, alkylbenzene sulfonic acid, or a mixture thereof.

15. The composition of claim 9, wherein the nonionic surfactant is an alcohol ethoxyxlate, block copolymer, amine oxide, alkylpolyglucoside, or combinations thereof.

16. The composition of claim 15, wherein the nonionic surfactant is a C10-C14 amine oxide and an alkylpolyglucoside in a ratio of about 1:5 to about 5:1.

17. The composition of claim 9, wherein the composition provides in a use solution from about 1 ppm to about 500 ppm quaternary ammonium compound, from about 10 ppm and about 500 ppm anionic surfactant, and from about 1 ppm and about 500 ppm nonionic surfactant, and wherein pH of the use solution is between about 6 and about 10.

18. The composition of claim 9, further comprising an additional functional ingredient selected from the group consisting of additional surfactants, solvents, humectants, metal protecting agents, stabilizing agents, corrosion inhibitors, sequestrants and/or chelating agents, solidifying agent, sheeting agents, pH modifying components, fragrances and/or dyes, hydrotropes or couplers, buffers, and combinations thereof.

19. The composition of claim 9, wherein the concentrate is a liquid composition that comprises from about 1 wt-% to about 40 wt-% anionic surfactant, from about 1 wt-% to about 60 wt-% nonionic surfactant and from about 1 wt-% to about 50 wt-% quaternary ammonium compound.

20. A method of cleaning a surface comprising:
providing a liquid or solid composition to a surface, wherein the composition comprises:
(i) a quaternary ammonium compound having the formula: 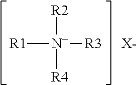
wherein groups R1, R2, R3, and R4 are independently selected from a C20 or less alkyl or alkoxy chain length, X— is an anion, and
an anionic surfactant having a C6-C18 chain length;
wherein the composition is a solid or liquid concentrate that is soluble in water, has a pH of about 1 to about 12 in a use solution, and provides at least a 3 log microbial kill on a treated surface; or
(ii) a propoxylated quaternary ammonium compound having the formula: 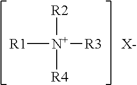
wherein groups R1, R2, R3 and R4 are independently selected from a C20 or less alkyl or alkoxy chain length, and wherein at least one of R1, R2, R3 and R4 is a propoxylated group, X— is an anion;
an anionic surfactant having a C6-C18 chain length;
at least one nonionic surfactant;
wherein the composition is a solid or liquid concentrate that is soluble in water at an actives level of at least 18% without the addition of a viscoelastic reducing agent, has a pH of about 1 to about 12 in a use solution, and provides enhanced soil removal with a stabilized foam in the presence of soil; and
optionally rinsing the surface in need thereof,
wherein the composition provides commercially acceptable cleaning performance, and
wherein the composition is effective at low and/or high temperatures.

21. The method of claim 20, wherein the solid composition is mixed into an aqueous use solution prior to applying to the surface in need of cleaning to dilutethe composition to provide a use solution providing from about 25 ppm to about 4000 ppm quaternary ammonium compound and from about 10 ppm and about 5000 ppm anionic surfactant, and optionally about from about 10 ppm and about 5000 ppm nonionic surfactant.

22. The method of claim 20, wherein the commercially acceptable cleaning performance provides an antimicrobial efficacy of at least a 3 log microbial kill on the surface, or removal of soil after contacting the surface for a sufficient period of time.

23. The method of claim 20, wherein the surface is ware.

24. The method of claim 20, wherein the surface is a human tissue.
